(19) United States
(12) Patent Application Publication
(10) Pub. No.: US 2024/0112511 A1
(43) Pub. Date: Apr. 4, 2024

(54) LOCK SYSTEM AND METHODS FOR USING THE SAME

(71) Applicant: RAV BARIACH (08) INDUSTRIES LTD., Ashkelon (IL)

(72) Inventors: Peter NICOARA, Ashdod (IL); Eran GOLDSTEIN, Givatayim (IL); Ilya DRALIUK, Ofakim (IL)

(73) Assignee: RAV BARIACH (08) INDUSTRIES LTD., Ashkelon (IL)

(21) Appl. No.: 18/277,070

(22) PCT Filed: Mar. 8, 2022
(86) PCT No.: PCT/IL2022/050262

§ 371 Date: Aug. 13, 2023

Related U.S. Application Data
(60) Provisional application No. 63/157,835, filed on Mar. 8, 2021.

(51) Int. Cl. G07C 9/00; E05B 63/14

(52) U.S. Cl. CPC G07C 9/00182; E05B 63/14

(57) ABSTRACT

The disclosure relates generally to a low-profile, electromechanical smart padlock that may be networked and remotely engaged by a consumer using a lock management system that may be accessed via a mobile computing device. Specifically, the disclosure relates to exemplary implementations of electromechanical padlocks, hasp locks and other electromechanical locks that can be configured to be networked to a central management system to provide selective secure proximity-based access to plurality of enclosures for a predetermined period.

### COPYRIGHTS NOTICE

A portion of the disclosure hereinbelow contains material that is subject to copyright protection. The copyright owner has no objection to the reproduction by anyone of the patent document or the patent disclosure as it appears in the Patent and Trademark Office patent files or records, but otherwise reserves all copyright rights whatsoever

### BACKGROUND

The present disclosure is directed to a low-profile smart padlock that may be remotely engaged by a consumer using a lock management system that may be accessed via a mobile computing device. The lock management system provides the user with an access code that may be transmitted to the smart padlock using Bluetooth® or other near field communications (NFC). One of the advantages the unique lock profile of the smart padlock described has, is the advantage that it can be positioned to lock a variety of structures that typically have insufficient space needed to accommodate the opening and closing of a conventional padlock.

Padlocks are frequently used to secure everyday items including everything from structures and buildings to containers, equipment, vehicles, lockers, and cables. The development of electromechanical padlocks has allowed people to continue to move away from physical keys which are often lost, and simple combinations which are often forgotten, in favor of programmable electronic keypads and fingerprint readers that allow them to access their locks.

While smart locks and card readers for building access have seen significant strides in the past decade, the advent of smart padlocks has been much slower. Unlike building smart locks which are fully wired, electromechanical padlocks use portable batteries making them subject to more constant maintenance or less reliability. In some instances, smart locks are controlled by software-based management systems which provide remote control over and access to the locking device; however, such management systems provide superior function when associated with wired systems since a remote lock must have sufficient power to receive signals and instructions from the remote management system.

A smart padlock is an electromechanical padlock which is designed to perform the locking and unlocking function after receiving instructions from an authorized device which acts as the key. The authorized device may be a key fob, remote or mobile computing device such as a phone.

U.S. Pat. Nos. 7,948,359 and 9,600,949, assigned to Master Lock Company LLC disclose smart padlocks and associated wireless systems for managing those locks. In one exemplary implementation of the '359 patent, a padlock includes a receiver arranged to receive a remote input signal including at least one authorization code. The lock includes a logic applying program to selectively store at least one access code, respond to a corresponding authorization code received by the receiver, and to energize the locking arrangement to move from the locked state to the unlocked state when the authorization code is received by the receiver. The '949 patent discloses an enhanced security system for a smart lock system that uses encrypted authentication files.

U.S. Pat. No. 10,679,441 assigned to The Sun Lock Company Ltd discloses a wireless communication system that uses a user device to receive an electronic signal capable of locking and unlocking an electronic locking device.

Published U.S. Patent Application No. 2021/0029489, assigned to Master Lock Company LLC discloses a cloud-based system for remotely managing a plurality of smart locks including delivering access credentials based upon the geolocation of the lock and at least one personal device of the user.

Power supply issues for electromechanical locks are addressed in a variety of ways. For example, U.S. Pat. Nos. 10,176,656 and 10,310,165, assigned to Noke, Inc. discloses an electronic lock that can become active from a low power state. Likewise, U.S. Pat. No. 8,806,907 discloses a system to prevent compromising a smart lock in the event an internal battery supply is depleted.

U.S. Pat. No. 10,458,153 to Rynan Technologies Pte., Ltd discloses a smart padlock that can be opened via one or more electronic interfaces or via a near field communication network such as Bluetooth®.

As can be seen from the foregoing, smart locking systems including smart padlocks are becoming more commonplace particularly as the use of smart phones has become ubiquitous. While the smart padlock as disclosed and described herein may include features common with the smart padlocks as described in the prior art, the smart padlock and lock management system provide a number of advantages not seen in the art.

It is with respect to these and other considerations that the disclosure made herein is presented.

### SUMMARY

In an exemplary implementation, provided herein is a low-profile locking device comprising: a lock housing having a channel for receiving an object to be secured; a lock housing cover; a locking structure contained between the lock housing and the lock housing cover that can be moved from a position inside the lock housing to a position spanning the channel when the locking device is locked.

In another exemplary implementation, provided herein is a locking system comprising: a low-profile locking device comprising a controller for receiving and executing locking instructions; a lock management system comprising a processor; and a non-transitory memory device for storing computer executable instructions in communication with the management system processor, the processor configured to execute the instructions to: determine, via a processor of an electronic key, that a locking device is proximate to the electronic key; determine, using user-specific data, authenticating the user (in other words, that the electronic key is appropriate to access the locking device by that user); send, responsive to determining that the access to the locking device by the electronic key is appropriate, a signal providing an access code; wherein the electronic key transmits the access code and locking instructions to the locking device via at least one of: Bluetooth® (BLE), near field communications (NFC), radio-frequency identification (RFID), ZIGBEE, WIFI and IOT Protocols (e.g., LoRA, NB-IoT, Thread).

In yet another exemplary implementation, provided herein is a non-transitory computer-readable storage medium storing thereon a set of instruction that when executed by one or more processors cause the one or more processors to perform the steps comprising: determining, via a processor of an electronic key, that a locking device is proximate the electronic key; determining, using user data, that the electronic key is appropriate to access the locking device; sending, responsive to determining that the access to the locking device by the electronic key is appropriate, a message providing an access code; wherein the electronic key transmits the access code and locking instructions to the locking device via Bluetooth® (BLE), near field communications (NFC), radio-frequency (RFID), ZIGBEE, WIFI and/or other IOT Protocols.

In yet another exemplary implementation, provided herein is a system for managing access to a plurality of enclosures; the system comprising: the plurality of enclosures, each enclosure configured to be enclosed using a networked lock; a plurality of the networked locks, each lock specifically associated with a corresponding enclosure, wherein each network lock comprises: a transceiver; a Bluetooth module; an electromagnetic motor; a locking mechanism coupled to the electromagnetic motor, operable to bias at least one ball bearing in a pair of ball toward an opposing ball bearing; and a processor, in communication with the transceiver, the Bluetooth module, and the electromagnetic motor, the processor being in further communication with a non-transitory memory device storing thereon a set of executable instructions, configured, when executed, to cause the processor to receive a pairing command from a backend management server; and using the Bluetooth pair the lock to a user's portable computing device. the backend management server, in communication with each transceiver of the networked locks, the backend management server, further comprises a central processor in communication with a non-transitory memory device storing thereon a set of executable instructions, configured when executed to: receive an inquiry from the user; obtain from the user a user identification; an enclosure location, an enclosure type; and duration of occupation of the enclosure; Upon payment by the user, issue to the user an enrollment code, the enrollment code specifically associated with the networked lock associated with the enclosure type in the location specified by the user; receive from the user the enrollment code; issue the pairing the networked lock associated with the enclosure type in the location specified by the user to pair.

### BRIEF DESCRIPTION OF THE DRAWINGS

The detailed description is set forth with reference to the accompanying drawings. The use of the same reference numerals may indicate similar or identical items. Various exemplary implementations may utilize elements and/or components other than those illustrated in the drawings, and some elements and/or components may not be present in various exemplary implementations. Elements and/or components in the Figures are not necessarily drawn to scale. Throughout this disclosure, depending on the context, singular and plural terminology may be used interchangeably.

FIG. 1 illustrates an exploded view of one exemplary implementation of a low-profile pad lock in accordance with the present disclosure.

FIGS. 2A-2C illustrate the padlock of FIG. 1 in the locked, unlocked and open positions.

FIG. 3A-3F illustrates views of the lock housing including an enlarged view of the locking bolt receptacle (3B).

FIGS. 4A-4C illustrate the application of the pad lock of the exemplary implementation of FIG. 1 to a device to be locked.

FIGS. 5A-5C illustrate a locker having a hasp and eyelet 170 closure and the padlock in accordance with FIG. 1 being used to secure the locker.

FIG. 6 illustrates an exemplary implementation having the locking device as described secured to the item to be locked.

FIGS. 7A-7C illustrate an alternative exemplary implementation of the low-profile padlock of FIG. 1 using a ball bearing closure rather than a conical bolt.

FIG. 8A-8D illustrates two alternative locking mechanisms 8A-8C, and 8D that may be used in place of the conical bolt used in the exemplary implementation illustrated in FIG. 1.

FIG. 9A-9E illustrate an alternative locking mechanism that uses a rotating slider bolt.

FIG. 10 illustrates a lock including both a ball bearing locking mechanism and a multipoint lock. Both are in the unlocked position.

FIG. 11A-11D illustrate a lock including both a ball bearing locking mechanism and a multipoint lock. The multipoint lock is locked and the ball bearing lock is unlocked.

FIG. 12A-12D illustrate a lock including both a ball bearing locking mechanism and a multipoint lock. Both are in the locked position.

FIG. 13 illustrates an exploded view of the additional security feature of FIG. 10.

FIGS. 14A-14C illustrates the operation of a low-profile lock that includes both a smart key capability and a physical key capability.

FIGS. 15-18 illustrate exemplary implementations of the locking device which are affixed to the object to be secured.

FIG. 19 illustrates the locking device used as an anti-theft device on a motorcycle.

FIG. 20A illustrates use of another exemplary implementation on a gate as a hasp lock, in the open configuration and in locked configuration in FIG. 20B.

FIG. 21A, illustrates an exemplary implementation of a low profile (meaning no extension outside the periphery of the padlock housing body) locker padlock, with FIG. 21B illustrating use of another exemplary implementation as a padlock (not low profile), in the open configuration and in locked configuration in FIG. 21C.

FIG. 22 illustrates use of another exemplary implementation as a (door) rim lock.

FIG. 23A, illustrates use of another exemplary implementation as a tethered lock, for example, with a bicycle in FIG. 23B.

FIG. 24A illustrates use of another exemplary implementation as a zipper tab lock, for example, with a suitcase in FIG. 24B.

FIG. 25 is a flow diagram illustrating one exemplary implementation of the lock management system according to the disclosure.

FIG. 26 is a flow diagram illustrating enrollment of a user and associated locking device in the lock management system.

FIG. 27 is a flow diagram illustrating one exemplary implementation of lock operation during use.

FIG. 28 is a flow diagram illustrating one exemplary implementation creating a one-time passcode to access or open a locking device as described.

FIG. 29A-29F illustrates implementations of various configurations of the smart lock (left) and corresponding controller (right).

FIG. 30A-30D, illustrates exemplary features for the controllers' configurations in FIGS. 29A-29F.

FIG. 31, illustrates an exemplary implementation of a networked system for plurality of locking device management.

FIG. 32, illustrates an exemplary implementation of the networked, electromechanical hasp lock, showing its internal components.

FIG. 33A, FIG. 33B, and FIG. 33C illustrate the assembly of the exemplary implementation of the networked, electromechanical hasp lock illustrated in FIG. 32

### DETAILED DESCRIPTION

### Overview

The following discussion is directed to various exemplary implementations of the invention. Although one or more of these exemplary implementations may be preferred, the exemplary implementations disclosed should not be interpreted, or otherwise used, as limiting the scope of the disclosure, including the claims. It is to be fully recognized that the different teachings of the exemplary implementations discussed below may be employed separately or in any suitable combination to produce desired results. Finally, one skilled in the art will understand that the following description has broad application, and the discussion of any exemplary implementation is meant only to be exemplary of that exemplary implementation, and not intended to suggest that the scope of the disclosure, including the claims, is limited to that exemplary implementation.

Certain terms are used throughout the following description and claims to refer to particular features or components. As one skilled in the art will appreciate, different persons may refer to the same feature or component by different names. This document does not intend to distinguish between components or features that differ in name but not structure or function.

As used in the following discussion and in the claims, the terms “including” “is”, “comprising”, “containing”, etc. are used in an open-ended fashion, and thus, should be interpreted to mean “including, but not limited to.” If closed language is included, “consisting,” and “consisting essentially of,” it should be given its art recognized meaning.

In one exemplary exemplary implementation, the locking device of the present disclosure is a low-profile smart padlock that may be opened by one or more electronic keys.

In another exemplary implementation, the locking device includes a channel in the lock body that accommodates the eyelet 170, cable or other feature to which the lock will be secured.

As used herein “low-profile” means that the lock as described doesn't include a shackle above the lock body. Low-profile makes no reference to and provides no limitation on the specific height or width of the locking device. The device may be any desired height and width depending upon the particular use for the locking device.

In another exemplary implementation, the locking device of the present disclosure is a smart locking device that may be controlled via a lock management system.

Each of the illustrated exemplary implementations includes smart features allowing for communication between the locking device and one or more other mobile computing devices. However, the novel “low-profile” lock profile as described may be associated with other physical, i.e., non-programmable, lock bodies that use keys, codes or other mechanical opening mechanisms, as appropriate. While described with respect to use as a fail-safe, one exemplary implementation of the low-profile locking device 10 can be seen in FIG. 14. If the controller were removed, the lock would be fully mechanical and that exemplary implementation is within the scope of the low-profile locking device as described herein.

In yet another exemplary implementation, the locking device of the present disclosure is a smart padlock having prolonged battery life. The locking device of this exemplary implementation may remain predominately in an unpowered configuration being awakened on an as-needed basis by the user. In certain exemplary implementations, the padlock battery can be rechargeable or non-rechargeable.

While the exemplary implementations described will be principally padlocks, any and all lock features associated with the padlock exemplary implementations may be used in locking devices that are permanently mounted to the object they will secure.

These and other advantages of the present disclosure are provided in greater detail herein.

### Illustrative Exemplary Implementations

The disclosure will be described more fully hereinafter with reference to the accompanying drawings, in which exemplary exemplary implementations of the disclosure are shown, are not intended to be limiting.

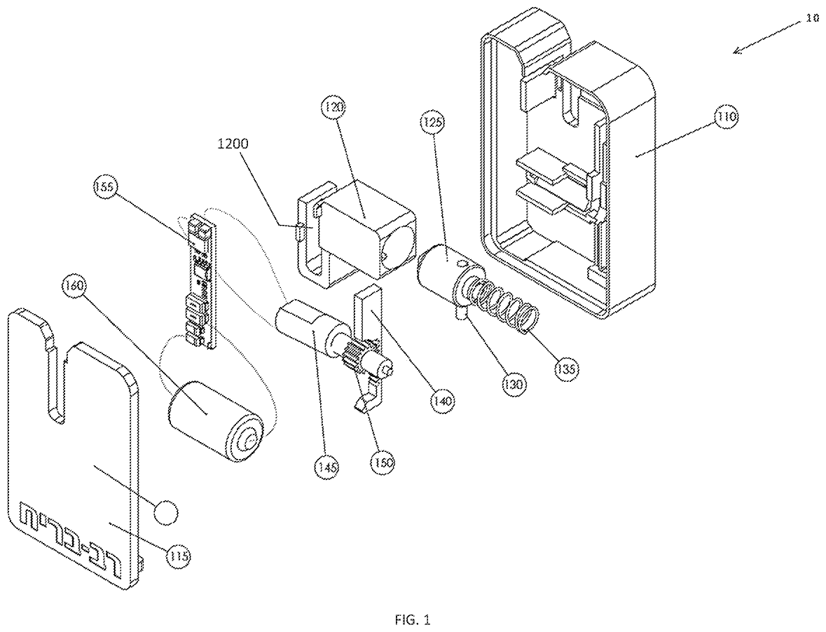

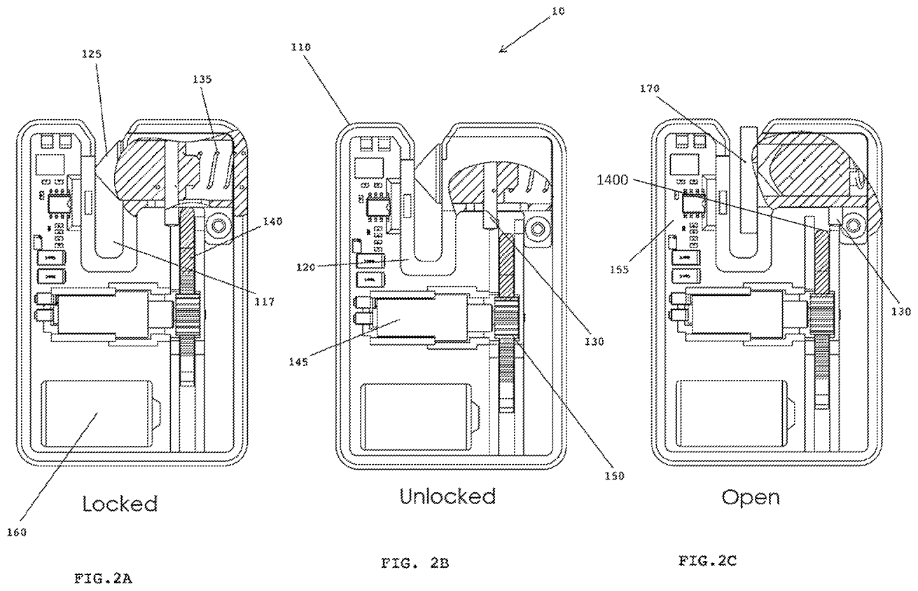

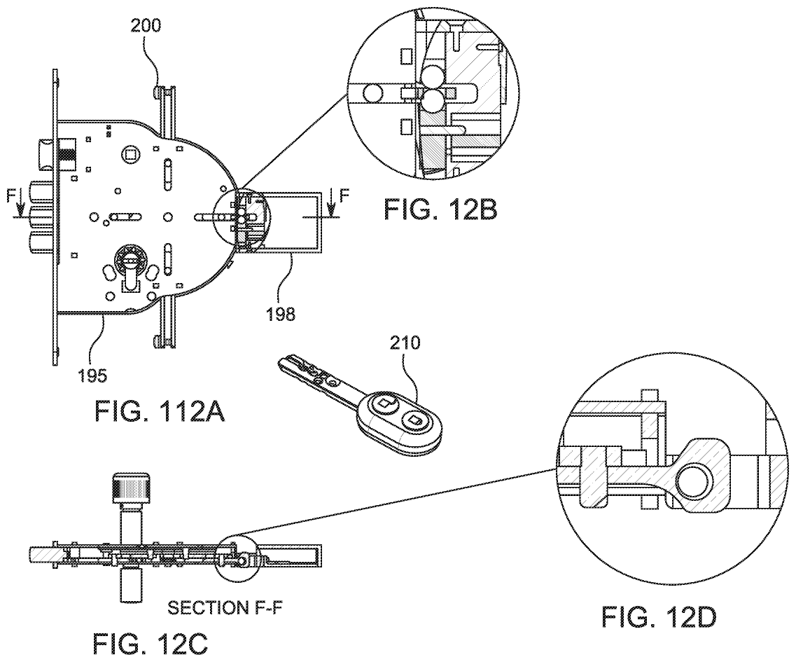

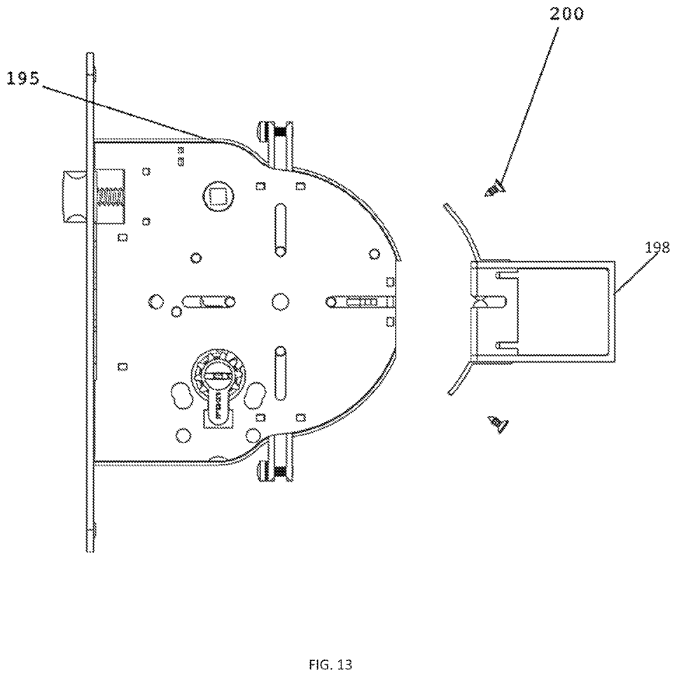

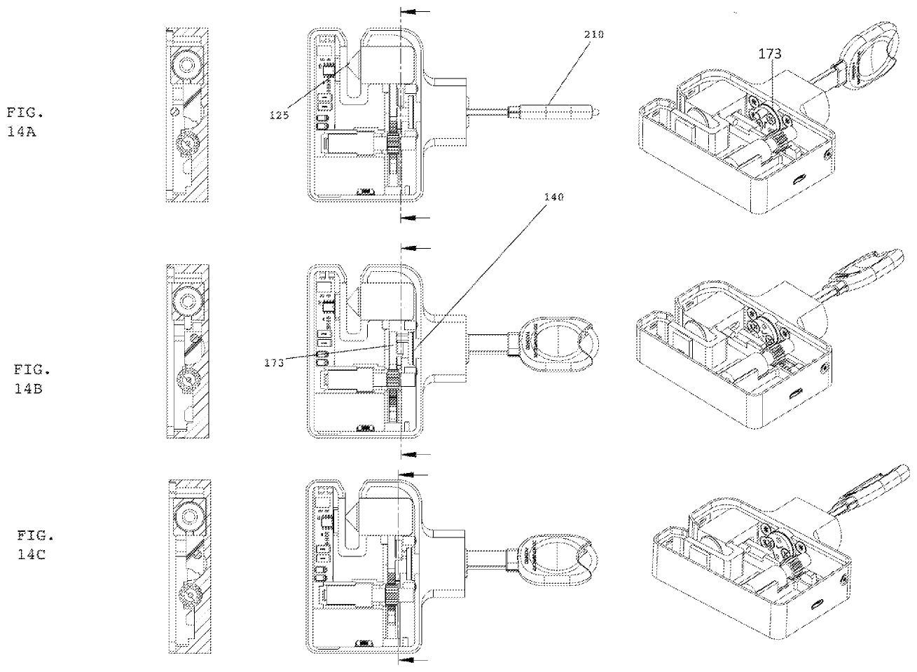

FIG. 1 illustrates an exploded view of low-profile locking device 10 of present disclosure. Locking device 10 is comprised of lock housing 110 which is coupled to lock housing cover 115. Lock housing 110 and lock housing cover 115 include a channel 117 (see e.g., FIG. 2B) sized and configured to surround and accommodate a eyelet 170, cable or other feature through which locking device 10 is to be secured. Inside lock housing 110 and proximate channel 117 is provided a locking pin housing 120. Locking pin housing 120 further defines channel 1200 that conforms to proximate channel 117 in lock housing 110 and supports locking bolt 125, locking pin 130 and bolt biasing element (e.g., spring, magnet, etc.) 135. In exemplary implementation shown, gear motor 145 is coupled to a pinion 150 along which a rack 140 travels. Pinion 150 may be spun via a gear motor 145 which may be driven by controller 155 that is coupled to a (rechargeable or non-rechargeable) battery 160 or via a key as described herein with reference to FIG. 12. Lock function will be described more fully with reference to FIGS. 2A-2C.

FIG. 2A illustrates locking device 10 of FIG. 1 in the locked position. Locking bolt 125 is a conical (or frusto-conical, or hemispherical, or pyramidal and the like) or any bolt which is urged forward by biasing element 135 to span the channel 117 causing locking bolt 125 to pass through a eyelet 170 (see e.g., FIG. 2C), or other feature which is to be secured (see e.g., 2303, FIG. 23A). In the locked position, gear motor 145 raises rack 140 via rotating pinion 150 until rack 140 apical end 1400 (see e.g., FIG. 2C) resides below locking bolt 125 and behind locking pin 130. Once rack 140 is in place behind locking pin 130, locking bolt 125 remains locked in place across channel 117.

FIG. 2B illustrates locking device 10 in an unlocked position. As seen in FIG. 2B, the gear motor 145 lowers the rack 140 via rotating pinion 150 until rack 140 apical end 1400 (see e.g., FIG. 2C) resides below the locking pin 130. Once the rack 140 is lowered, locking bolt 125 is free to move laterally to retract from the eyelet 170 or other feature through which it was secured. According to the exemplary implementation shown, locking device 10 in the unlocked position remains in place until locking bolt 125 is retracted, thereby preventing the lock from shifting or falling from its position when the lock is released by the electronic key.

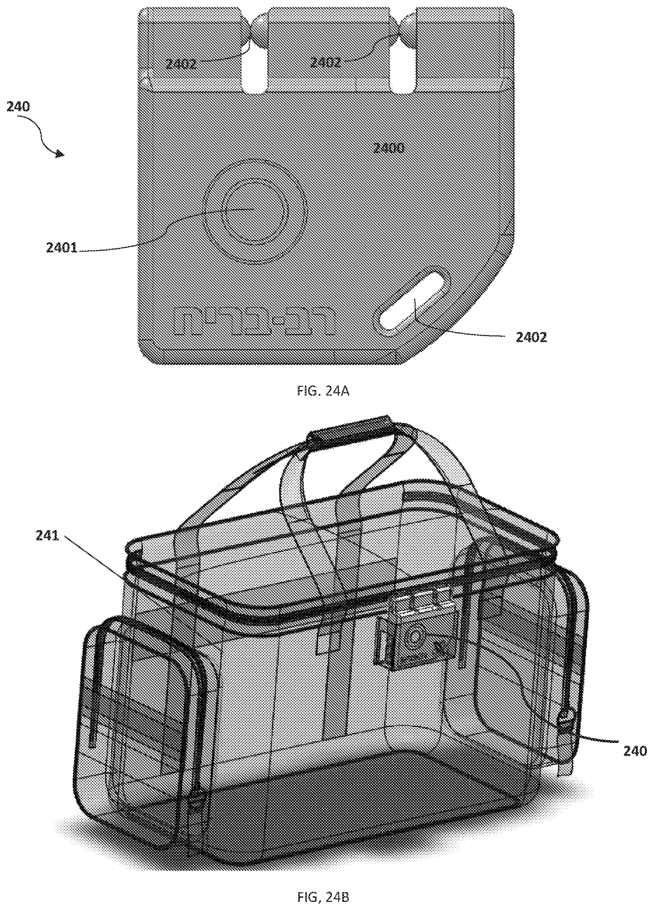

FIG. 2C illustrates locking device 10 in the open position with the biasing element 135 compressed and locking bolt 125 retracted from channel 117 and back into locking pin housing 120. In one exemplary implementation, locking device 10 may be held in the open position by raising rack 140 apical end 1400 in front of locking pin 130. The exemplary implementation illustrated, shows channel 117 around a eyelet 170 or feature to be locked (see e.g., zipper ends of suitcase illustrated in FIG. 24B).

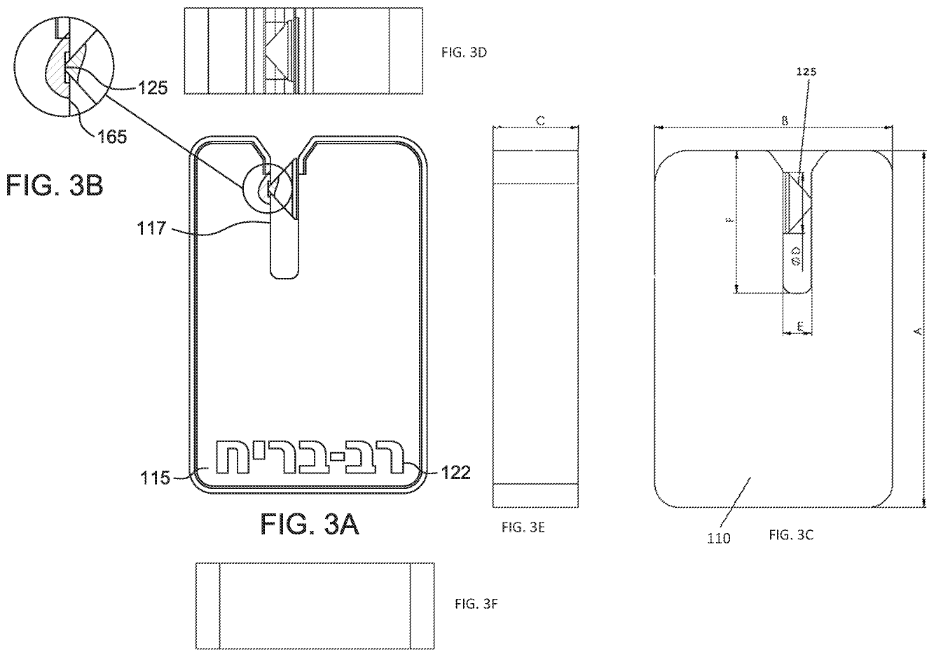

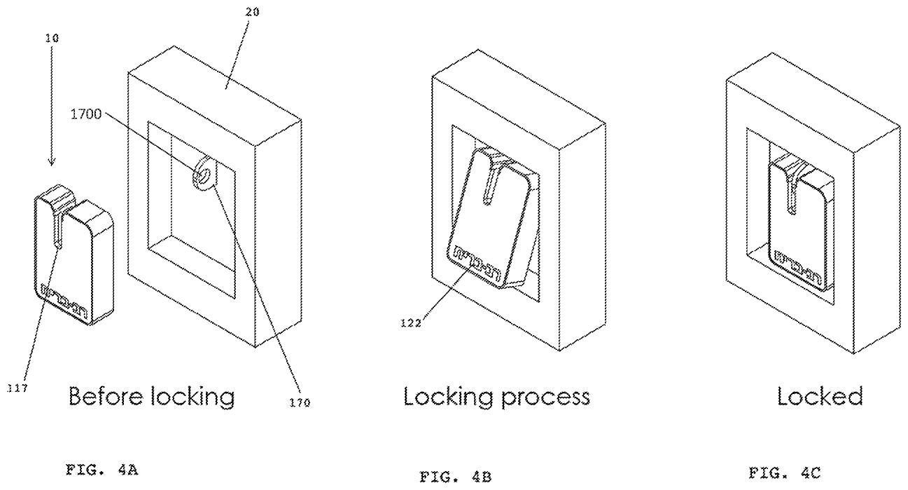

FIGS. 3A-3F illustrate various views of locking device 10 including front (3A), back (3C), top (3D), bottom (3F), and side (3E) views of lock housing 110 and lock housing cover 115 with FIG. 3B, being an enlargement of the circled area in FIG. 3A. In exemplary implementation, locking bolt 125 is urged across channel 117. In enlarged partial view 3B, tip of conical locking bolt 125 is secured in a recess 165. As seen in FIG. 3B, recess 165 is an indentation that accommodates tip 1250 of conical locking bolt 125. shape of recess 165 can be readily modified to accommodate a different profile shape associated with locking bolt 125. Recess 165 may be included in locking pin housing 120 or may be in lock housing 110 as desired. As seen in FIG. 3A, lock housing cover may include indicia or other markings 122 that identify lock manufacturer, business or school using lock, a unique lock identifier (e.g., QR Code) or any other type of indicia desired. In e.g., FIG. 3C, height of lock is identified by line A, width of lock is identified by line B, depth of lock is identified by line C, line D identifies outside diameter of a conical locking bolt 125 and lines E and F refer to width and depth of channel 117, respectively. Specific dimensions of lock 10 may be modified to accommodate size, space requirements and orientation of object to be locked. Furthermore, lock 10 may be increased in size or decreased in size based upon level of security desired. In other words, bolt 125 diameter, tip 1250 shape and size may be modified to withstand greater force to prevent removal of lock 10 or any member engaged by tip 1250.

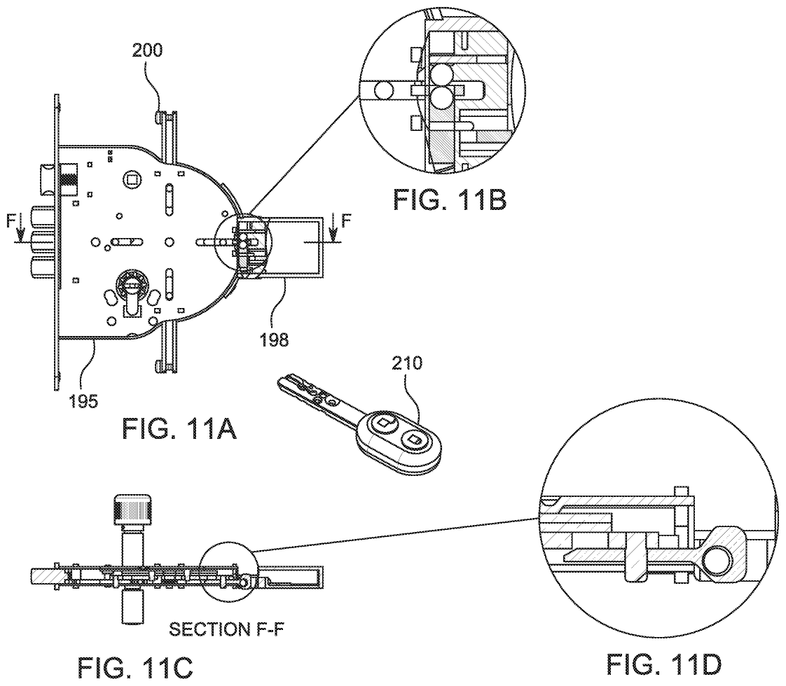

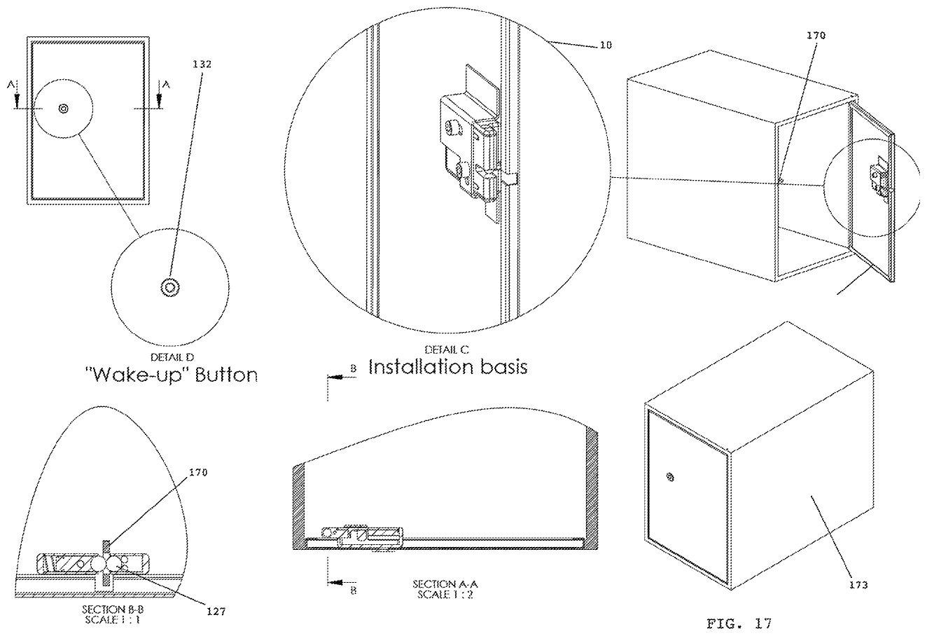

In an exemplary implementation, locking device 10 includes a “wake-up” button 132 (shown in FIG. 17) which moves lock from an off position to an active position. By maintaining lock in a powered off position except during periods of use, battery life on locking device 10 is significantly prolonged over other similar devices. In some exemplary implementations, lock 10 may include a low-battery indicator. Low battery indicator may be a physical indicator on lock 10 itself or it may be an electronic indication that is transmitted between controller 155 and electronic key (see e.g., 210, FIG. 11A). While, device start button, “wake-up” button 132 in this exemplary implementation is configured as a physical button, or an initiation devices may be used. For example, wake-up function may be carried out using at least one of: a motion detector, a proximity sensor, and a sound detector that may receive a word or signal from a user or a mobile computing device. The skilled artisan will readily recognize that any art recognized devices to cause actuating of locking device 10 can be used in place of a physical button.

FIGS. 4A-4C show locking device 10 secured to an object 20 which includes a eyelet 170. In practice, eyelet 170 is secured to a wall, door or other object to be secured 20. Channel 117 of locking device 10 placed to accommodate eyelet 170 and locking bolt 125 is moved laterally through the aperture 1700 defined in eyelet 170. Once the locking bolt 125 traverses eyelet 170, rack 140 would be raised via rotating pinion 150 and gear motor 145 to keep locking bolt 125 in the locked position.

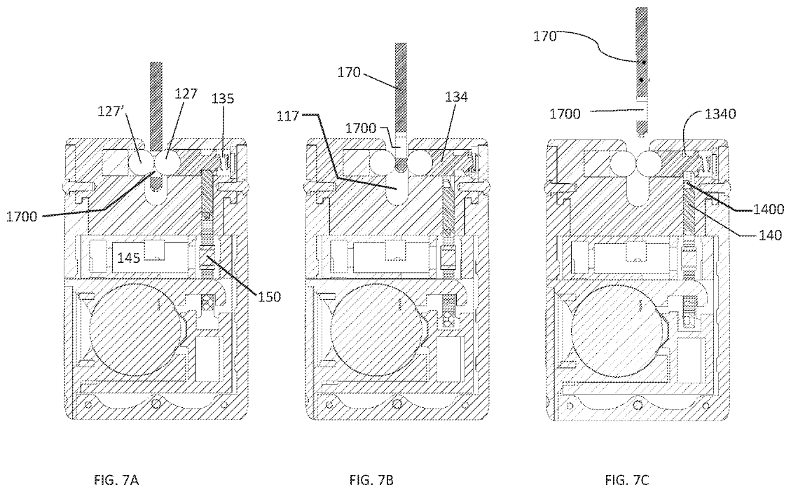

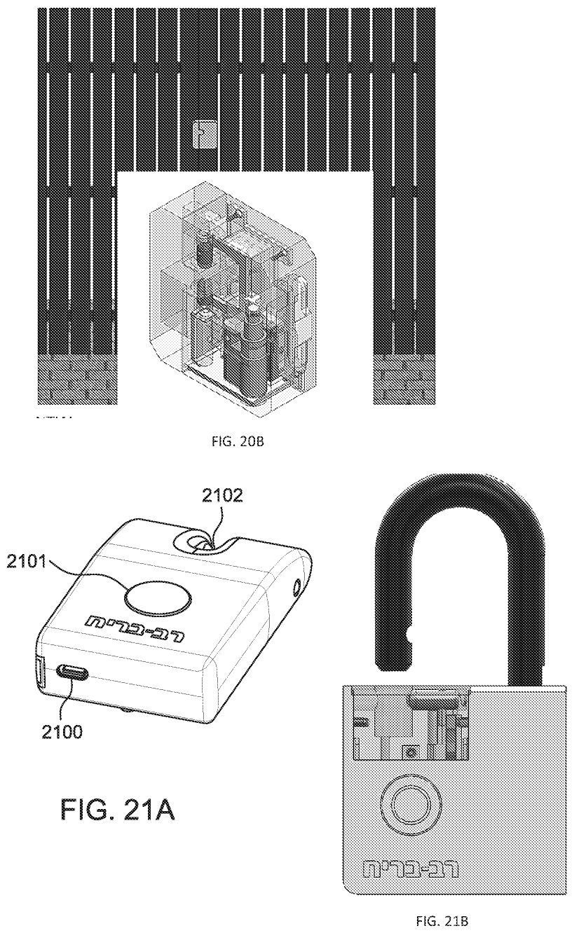

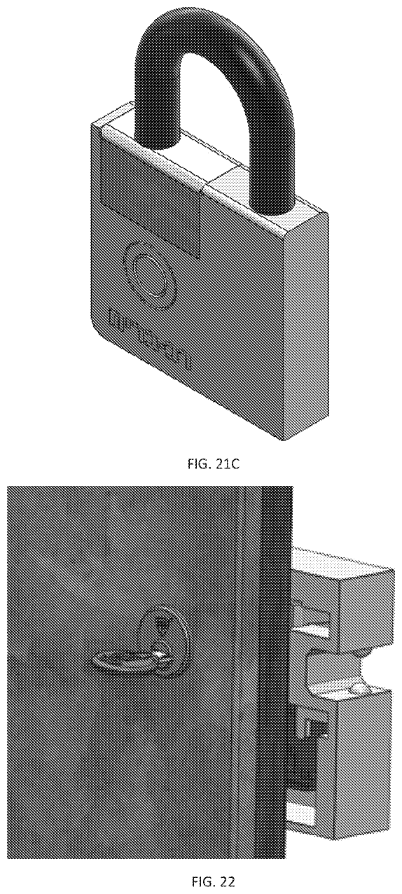

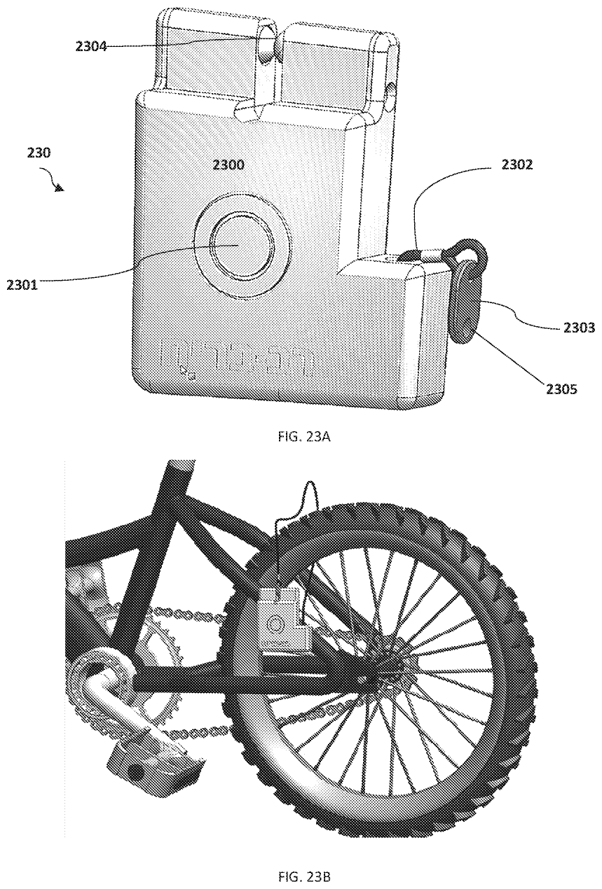

As will be readily apparent to the skilled artisan, the object through which locking device 10 is secured can be any object that defines an aperture that can accommodate the locking bolt 125. Further, as will be understood based upon the description herein, the size of the channel 117 in locking device 10 will depend upon the objects to be secured. While the channel 117 shown in e.g., FIG. 4A is relatively narrow, the channel may be made wider if, for example, the locking device needs to accommodate two rings or another wide feature. A wider channel 117 can be seen for example in the enlarged partial view of FIG. 19 which shows a locking device 10 that can accommodate a disc brake on a motorcycle. Similarly, as illustrated in FIGS. 20A-24B, and according to another exemplary implementation, the channel 117 can be covered on one side to prevent lock tampering. As illustrated in FIGS. 20A, 20B, and 32-33C, lock 10 can be adapted as a hasp lock, for large gates, as a regular latch lock in FIGS. 21B-21C, as a door rim lock in FIG. 22, and as a bike lock, whereby lock 230, with housing 2300 and actuation button 2301 (e.g., wake-up button, a fingerprint scanner, a retinal scanner, a voice recognition module, or a combination of the foregoing [see also 2401, FIG. 24A]) equivalent to lock 10, further comprises retractable cable 2302, with eyelet 2303 coupled to retractable cable 2302, such that eyelet 2303 defining an aperture 2305 sized and adapted to be engaged by spheres 2304 (see e.g., FIG. 7A). FIG. 21A illustrates an exemplary implementation of networked, low-profile lock 10, whereby charging port 2100 is used to charge a rechargeable battery, with button 2101 that can be at least one of: a power up (“wake-up”) button, and a biometric sensor (for example; a fingerprint scanner, or a retinal scanner, or a voice scanner) with pair of bearings 2102 (see e.g., FIGS. 7A-7C). In the context of the disclosure, the term “low-profile” in relation to a lock means that, in its mated configuration (see e.g., FIGS. 4C, 5C, and 7A) the lock has an engaged portion that is not deep enough to be easily gripped by multiple fingers. The term “low-profile” may therefore refer to locks which, when mated to an eyelet 170 have an engaged portion for manual gripping that is less than 30 mm deep. The eyelet material, geometry and strength will be adjusted to the pull force resistance required for the security level of the lock type (e.g., padlock, hasp lock, etc.) to be, for example: 250, 500, 1,000 Kg. Force (KgF).

In this exemplary implementation, locking case cover 115 does not define channel 117 but would fit over locking case 110. Accordingly, locking device 10 is placed over a eyelet 170 or other object to be secured from back or top of locking device 10 and engaged using electronic key. While locking device 10 remains on object, neither the user nor any third party would have access to locking mechanism.

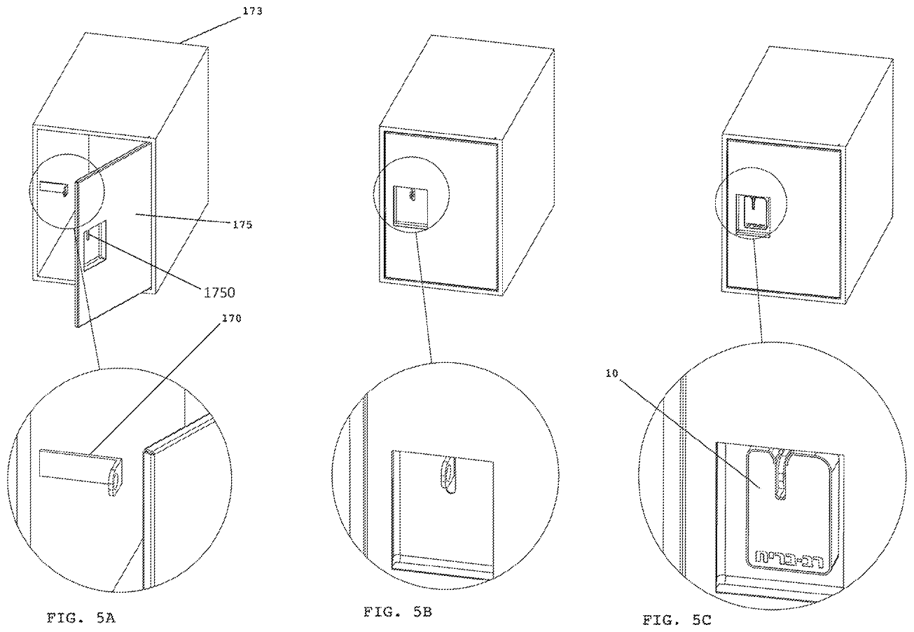

FIGS. 5A-5C illustrates a locker assembly 173 which uses an L-shaped eyelet 170 to pass through slot 1750 defined in locker door 175, configured to accommodate a portion of L-shaped eyelet 170 including aperture 1700. As illustrated in FIG. 5A, locker door 175 is open and as can be seen in the partial enlarged view (FIG. 5A, bottom), L-shaped eyelet 170 is coupled to the inside of the locker assembly 173. In FIG. 5B, locker door 175 is closed and eyelet 170 passes through slot 1750 in the locker door 175. Locking device 10 may be applied to the eyelet 170 outside the locker door 175 in the same manner as described in FIGS. 4A-4C. As seen in FIG. 5C, locking device 10 secures the locker door in the closed position. It is noted, that the systems disclosed herein are used in certain exemplary implementations, to manage the lockers with the installed locking devices, for example, in schools, gyms and the like.

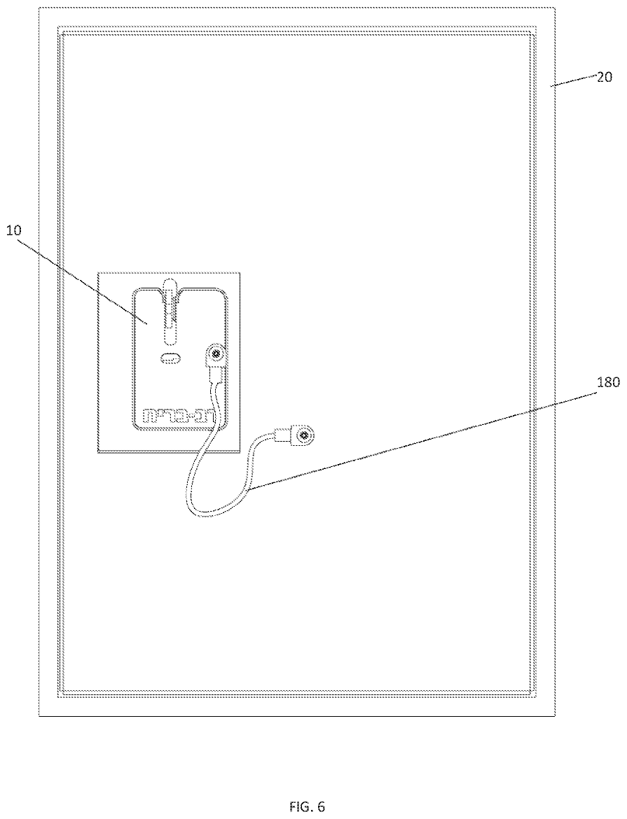

FIG. 6 illustrates an exemplary implementation where locking device 10 is secured to the object 20, e.g., the outside of the locker 173, so that the lock may not be misplaced or lost. As seen in FIG. 6, locking device 10 via the lock housing 110 or the lock housing cover 115 can be coupled to a cable 180 which is also coupled to the object 20.

FIGS. 7A-7C illustrate a front cut-away elevation view of a locking device 10 as described herein. As seen in FIG. 7A, the locking bolt 125 may be replaced with a pair of ball bearings 127, 127′ where at least one of the ball bearings is adjacent to biasing element-actuated piston 134 that moves the ball bearing laterally to span the channel 117 in locking device 10.

FIG. 7A illustrates ball bearing 127, 127′ of locking device 10 in the locked configuration. Piston 134 having posterior groove 1340 (see e.g., FIG. 7B) is urged forward by biasing element 135 to span channel 117 causing ball bearings 127 to move into locked engagement (see e.g., FIG. 24B, showing an object being secured between the ball bearings). In operation, ball bearings 127, 127′ would each partially pass through eyelet 170 or other feature which is to be secured. In the locked position, gear motor 145 (not shown) raises the rack 140 via pinion 150 until rack 140 apical end 1400 resides below piston 134 and behind locking pin 130. Once the rack 140 apical end 1400 engages groove 1340, piston 134 cause ball bearings 127, 127′ to remain in contact and locked in place across channel 117. In certain exemplary implementations, apical end 1400 defines a Y-shaped apical end (means three webs of a structural member arranged so that their cross-sectional shape, or configuration, is in the general shape of a “Y”), whereby the apical webs are sized and configured to engage piston 134 in groove 1340 from opposite ends, thus engaging a larger portion of piston 134 periphery. In the context of the disclosure, the term “engage” and various forms thereof, when used with reference to retention of an engaged element, refer to the application of any forces that tend to hold the engaging element (e.g., Y-shaped apical end 1400) and the engaged element (e.g., piston 134 via groove 1340) together against inadvertent or undesired separating forces (e.g., such as may be introduced during an attempt to pry the lock). The term “engaged” may mean, in other exemplary implementations, the interlocking of two or more components of the device, e.g. a spline, thread, or meshed teeth connection. It is to be understood, however, that engagement does not in all cases require an interlocking connection that is maintained against every conceivable type or magnitude of separating force.

FIG. 7B illustrates locking device 10 in an unlocked configuration. As seen in FIG. 7B, rack 140 apical end 1400 is lowered disengaging from groove 1340. Once rack 140 apical end 1400 is lowered, piston 134 is free to move laterally to retract from eyelet 170 aperture 1700 or other feature through which it was secured.

FIG. 7C illustrates locking device 10 in the open configuration, with biasing element 135 compressed and piston 134 being free to move laterally away from channel 117 and back into locking pin housing 120 (not shown). In an exemplary implementation eyelet 170 or other feature to be secured is lowered between ball bearings 127, 127′ whereby each partially pass through the eyelet 170 aperture 1700 and abut each other to keep the lock in position so that the apical end 1400 of rack 140 can be raised and engage groove 1340, locking device 10. The configuration illustrated in FIGS. 7A-7C can be adapted to be used as illustrated in FIG. 24A, with lock 240, comprising housing 2400 defining plurality of channels 2402, sized and configured to accommodate eyelet aperture 1700 defined for example in suitcase 241 (see e.g., FIG. 24B, element 2305, FIG. 23A) zipper tab.

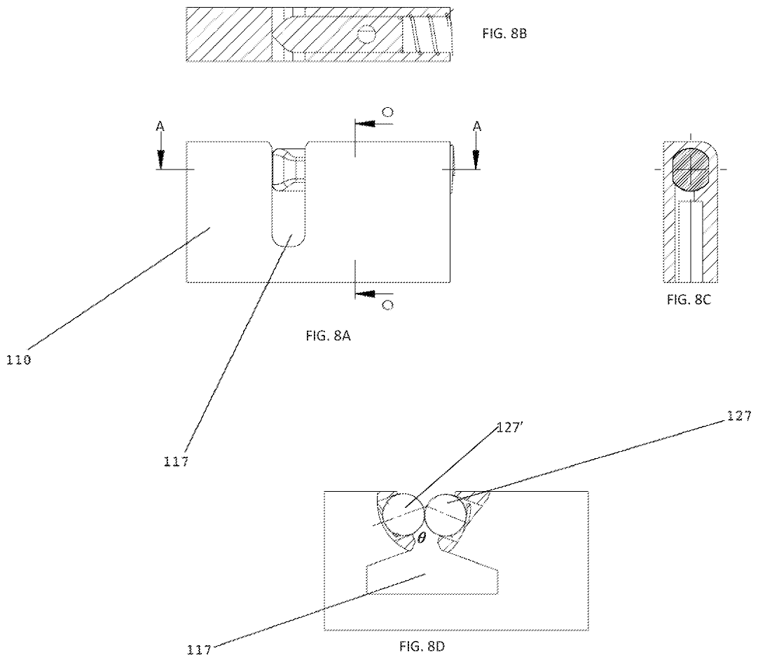

FIG. 8A-8D illustrate two alternative implementations of locking mechanism 10 that may be used in place of the conical bolt 125 illustrated in FIG. 1. The first alternative exemplary implementation illustrated in FIGS. 8A-8C, is labelled a “Double D” bolt and rather than having a conical cross section (see e.g., FIG. 3D), bolt 125 includes a double chaffered cross-section (see e.g., FIG. 8C). The Double-D bolt 125 is shown in FIG. 8C in cross-sectional along line 0-0, and along line A-A in FIG. 8B. The second exemplary implementation illustrated in FIG. 8D, is an angled ball-bearing option that is similar to the ball bearing locked detailed in FIG. 7. The only difference is the channel 117 is enlarged and reoriented and the ball bearings' cross section centerline do not meet at a 180° angle and instead contact one another at a predetermined angle θ, for example at about 210° or about 225°. As will be readily apparent to the skilled artisan, the channel configuration and the manner of contact between ball-bearings 127, 127′ can be readily changed and are within the spirit and scope of the locking devices as described herein.

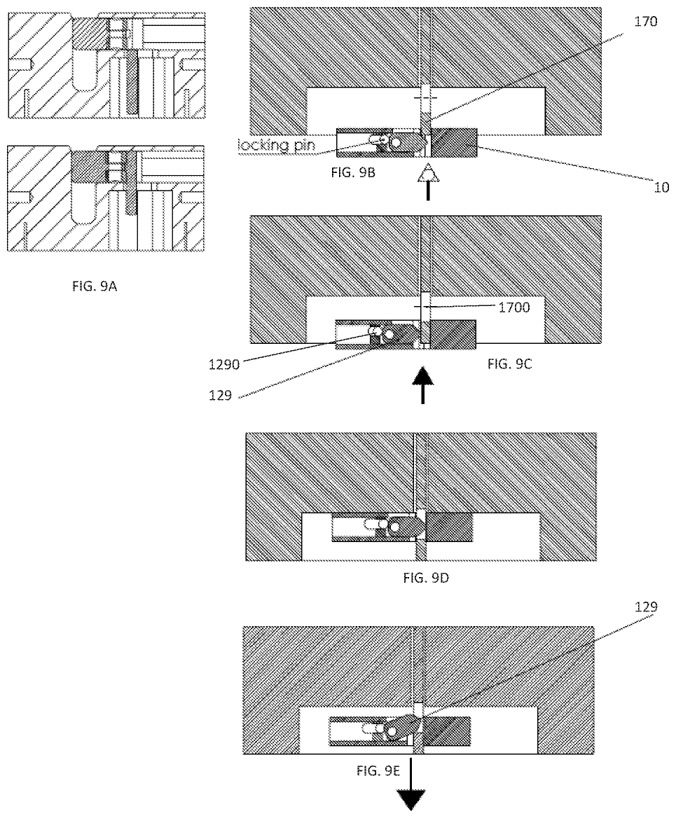

FIGS. 9A-9E illustrate another alternative exemplary implementation to locking bolt 125 as described with reference to FIG. 1. FIG. 9A, illustrates a cross section of the lock in the unlocked configuration (top), and unlocked configuration (bottom), and in FIGS. 9B-9E, during actuation of the lock. As illustrated, for example in FIG. 9B, laterally sliding bolt 125 is replaced with bolt 129, configured such that it can both be hingedly” and slidably coupled to lock 10. As can be seen in FIGS. 9B-9E, locking device 10 including hingedly and slidably coupled bolt 129 can be inserted around a latch or eyelet 170 aperture 1700. Upon insertion of eyelet 170 (9B), with locking pin 1290 retracted (9C), bolt 129 slides back enough to provide clearance for the eyelet 170 and then springs forward to span eyelet 170 aperture 1700 and once eccentric locking pin 1290 is urged forward, keep the object locked in place (9D). When the lock is to be removed, eccentric locking pin 1290 is again retracted (9E) the bolt 129 rotates and slides to allow locking device 10 to be retracted from eyelet 170 aperture 1700.

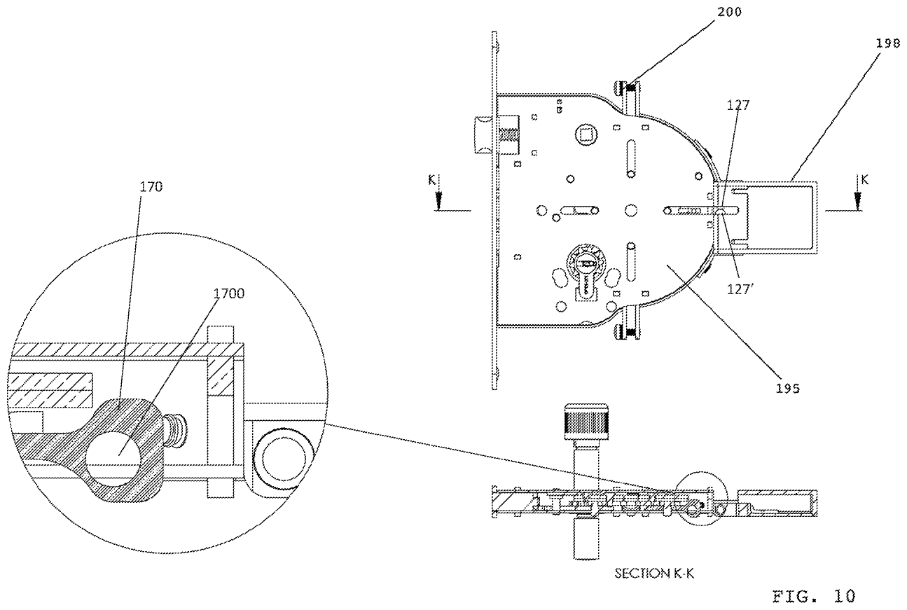

FIGS. 10-12 illustrate a combination locking system that includes both an electromechanical smart locking device 10 (see e.g., FIGS. 7A-7C) coupled with multipoint mechanical lock system. Such a system can take the place of, for example, secure structures that currently require two mechanical keys to open, for example, a safe-deposit box. While the exemplary implementation shown and described relates to the low-profile locking device 10, the combined use of a smart locking system with a mechanical locking system to provide enhanced security can be achieved using any art recognized smart lock configurations or mechanical lock configurations as will be readily apparent to the skilled artisan.

FIG. 10 illustrates a combined mechanical lock and smart locking system. As seen in FIG. 10 the mechanical lock 195 is secured to the object to be secured by bolts 200. The smart locking system 198 is coupled to the mechanical lock and secures one or more features within the mechanical lock 195. As can be seen in the cross-section K-K both the mechanical lock 195 and the smart locking system 198 are unlocked. It is noted that in the locked configuration, eyelet 170 aperture 1700 will be engaged between ball baring 127, 127′.

FIG. 11 illustrates a combined mechanical lock and smart locking system in the locked configuration. As seen in FIG. 11 the mechanical lock 195 is secured to the object to be secured by bolts 200. The smart locking system 198 is coupled to the mechanical lock and secures one or more features within the mechanical lock 195. As can be seen in the cross-section F-F in an enlarged partial view, the mechanical lock 195 is locked. As can be seen in the enlarged partial view of the smart lock 198, the smart locking system 198 remains unlocked.

FIG. 12A-12D illustrates in FIGS. 12A, and enlarged portion 12B a combined mechanical lock 195 and a smart locking system 198. As seen in FIGS. 12C and 12D the mechanical lock 195 is secured to the object to be secured by bolts 200. The smart locking system 198 is coupled to the mechanical lock and secures one or more features within the mechanical lock 195. As can be seen in the cross-section F-F in an enlarged partial view, the mechanical lock 195 is locked. As can be seen in the enlarged partial view of the smart lock 198, the smart locking system 198 has also been locked. In an exemplary implementation, key 210 can be used to unlock either mechanical lock 195, or locking system 198, following authentication that key 210 is authorized to actuate locking system 198 as will be described.

According to one exemplary implementation, the combined locking device shown FIGS. 10-12 can be controlled as follows. The smart locking system 195 may be activated by an electronic key 210, for example, a remote-control using radio frequency or Bluetooth®. Only after the smart lock has been opened by an authorized user using an appropriate electronic key will the mechanical lock 195 be openable.

According to another exemplary implementation, the locking device may be placed on an object to be secured, e.g., a latch, eyelet 170 or bracket. The mechanical lock 195 is then secured using a key 210. In an exemplary implementation, mechanical key 210 is integrated with a smart key fob which can provide a single instrument to control locking device 10 of locking system 198. As will be understood by the skilled artisan, an integrated mechanical/electromechanical key may provide less security than a mechanical key that is separate from a smart key fob, or mobile computing device, which can together provide two-layer authentication of the user.

To open the lock, electronic key 210 is operable to instruct smart lock 198 to release eyelet 170 aperture 1700 for a predetermined period of time, for example, 30 seconds. During that period, the mechanical lock can be disengaged using, for example, a key or a thumb turn. Smart locking system 198 will remain in the open configuration until mechanical lock 195 is reengaged. Once the mechanical lock is reengaged, the smart locking system 198 can automatically transition to the locked configuration or be controlled by the electronic key, as desired.

FIG. 13 illustrates on exploded view of one exemplary implementation where a mechanical multipoint lock 195 is operably coupled to electromechanical locking device 198 using screws 200. As seen in FIG. 13, the electromechanical locking device 198 can be positioned for attachment to many pre-existing mechanical locks 195. In an alternative exemplary implementation, electromechanical locking device 198 can be produced as an integrated (monolithic) part of a locking device 10 having both an electromechanical portion and a fully mechanical portion.

As used herein “locking structure” refers to the mechanism that is used to close the channel 117 in the lock housing. The locking structure can include the locking bolt (conical or otherwise), the locking bar, the ball bearing assembly, the rotatable pin, as described, or any other art recognized arrangement that can close the channel and secure locking device 10. When an exemplary implementation is described with reference to one of these locking structures it is understood that any of the other locking structures may be used in that exemplary implementation.

FIGS. 14A-14C illustrate an exemplary implementation of a mechanical back up system for a smart locking device 10 as described herein. As illustrated in FIG. 14A, key 210 is operable to turn a cam 173 moving the rack 140, allowing key 210 to open and close the locking device without the need for external power. FIG. 14A illustrates the key being inserted. FIG. 14B illustrates the key engaging the cam 173 and moving the rack 140. FIG. 14C illustrates the rack re-engaging after being opened.

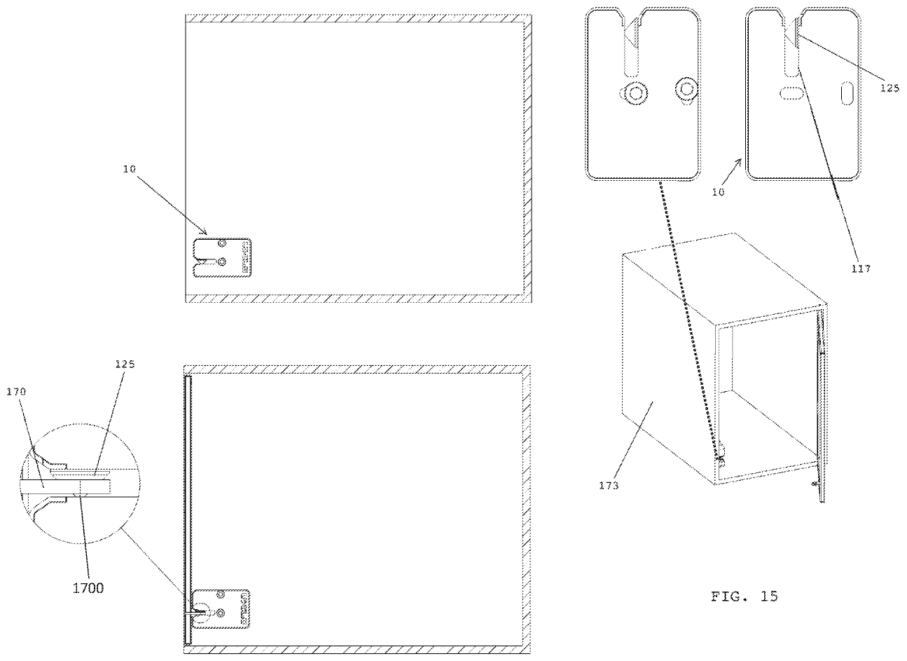

FIG. 15 illustrates an exemplary implementation where locking device 10 is secured to inside of a locker assembly 173. As illustrated, locking device 10 is secured to side of locker 173 proximate locker door 175 with channel 117 pointing toward opening. Eyelet 170 is coupled to locker door 175 and aligned with channel 117. When locker door 175 is closed, eyelet 170 is accommodated in channel 117 and locking bolt 125 passes through eyelet 170 aperture 1700 securing locker door 175. Once locker 173 is closed, electronic key can be used to instruct lock controller 155 to unlock locker 173. Upon instruction, controller 155 initiates gear motor 145 to rotate pinion 155 thereby moving rack 140 apical end 1400 up behind locking pin 130 thereby securing locking device 10. Locking device 10 is invisible from outside of locker making it difficult for anyone to attempt to gain entrance without an electronic key.

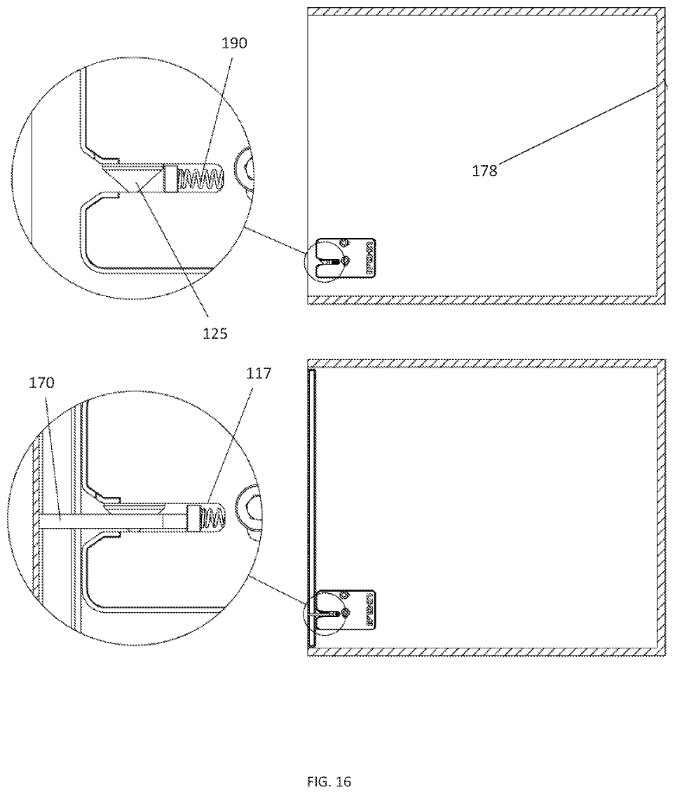

FIG. 16 shows an internally mounted locking device 10 as previously seen in FIG. 13. As illustrated, locking device 10 further includes biasing element assembly 190 which is compressed when the eyelet 170 is pressed into channel 117 and which releases when locking device 10 is opened causing the eyelet 170 and door 175 of the locker assembly 173 to open. With reference to FIG. 2, the biasing element assembly 190 would be perpendicular to locking bolt 125 and between gear motor 145 and locking bolt 125.

FIG. 17 illustrates an exemplary implementation whereby locking device 10 is secured to locker door 175. As illustrated, locking device 10 is secured to side of locker door 175 proximate edge of door with channel 117 parallel to bottom of locker assembly 173. Eyelet 170 is coupled to inside of locker assembly 173 and aligned with channel 117. When locker door is closed, eyelet 170 is accommodated in channel 117 and locking bolt 125 passes through eyelet 170 aperture 1700 securing locker door 175. Once locker 173 is closed, electronic key (210 e.g.,) can be used to instruct lock controller 155 (not shown, see e.g., FIG. 1) to lock locking device 10. As illustrated, in this exemplary implementation, the locking structure is pair of ball bearing that span eyelet 170 aperture 1700 thereby locking device. Upon instruction, controller 155 is operable to actuate gear motor 145 (not shown, see e.g., FIG. 1) to rotate pinion 155 (not shown) thereby moving rack 140 apical end 1400 (not shown) up behind locking pin 130 thereby preventing movement of ball bearings 127, 127′ and securing locking device 10. Again, locking device 10 is not visible from outside of locker 173 thereby providing enhanced security by making it difficult for anyone to attempt to gain entrance without electronic key. In exemplary implementation shown, locking device 10 includes wake-up button 132 which can be installed and accessed through locker door.

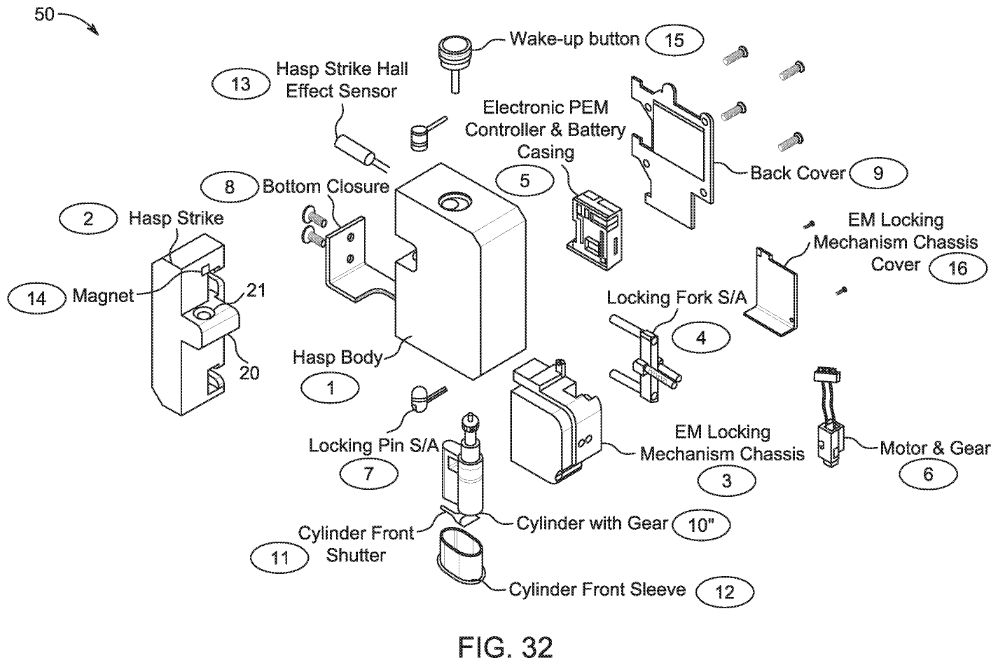

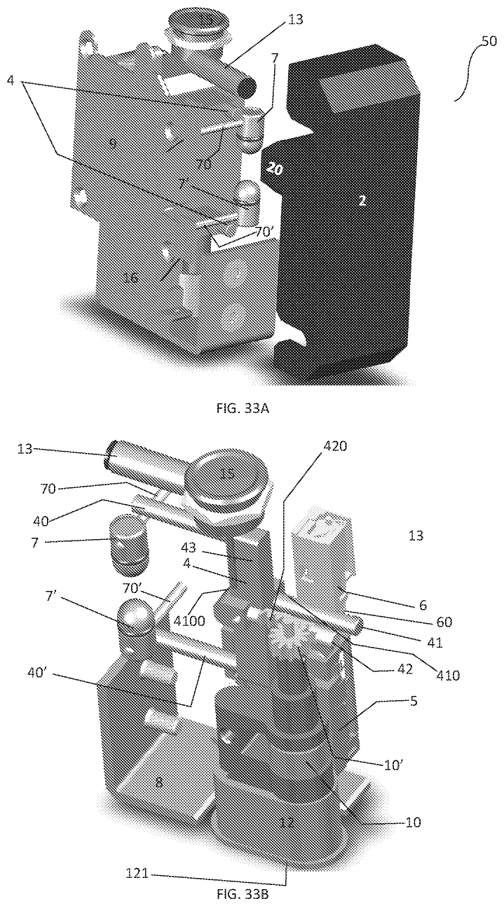

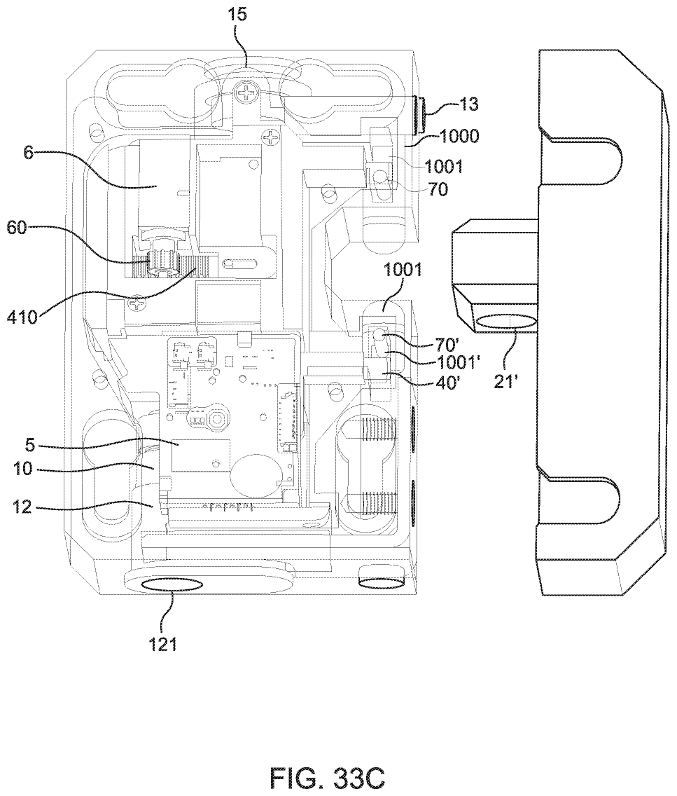

Turning now to FIGS. 32-33C, illustrating Hasp lock 50, comprising hasp body 1 and hasp strike 2. As illustrated in FIG. 32, hasp strike 2 further comprises magnet 14 embedded within hasp strike 2, configured to communicate with sensor 13, to indicate gate closure. Also illustrated is locking chassis 3, locking fork 4, lock controller and battery casing 5, and motor 6, comprising spur gear 60 (see e.g., FIG. 33C). Also illustrated in FIG. 32, is locking pins 7, 7′ operable to engage depressions 21, 21′ defined in protrusion 20 of hasp strike 2. Bottom closure 8, and back cover 9 (of locking chassis 3) are also illustrated. Cylinder locking mechanism 10″, having spur gear 10′ (see e.g., FIG. 33B) forms a component in an assembly comprising cylinder front shutter 11 cylinder front sleeve 12, and key way 121 defined in Cylinder locking mechanism 10″. Turning now to FIGS. 33A-33C, illustrating open hasp lock 50, with hasp body 1 removed, and has strike 2 decoupled. As illustrated in FIG. 33B, locking fork is comprised of upper rod 40, lower rod 40′, coupled to locking fork 4 body 43, with rack 41 with gear ridges 410 abutting a biasing element 4100 (Not shown) embedded within fork body 43, engaging spur wheel 60, operably coupled to motor 6, such that when, upon receiving command from user 700 app, via lock controller and battery casing 5 (comprising Bluetooth module, and transceiver), will rotate spur wheel 60 on rack 41, causing locking fork 4 to translate laterally (forward, toward hasp strike 2, such that upper rod 40, and lower rod 40′ will bracket lateral rod 70, 70′ of locking pin 7, 7′, respectively, preventing locking pins 7, 7′ each comprising a biasing element configured to urge each locking pin 7, 7′ into depression 21, 21′ respectively in hasp strike 2 from disengaging (see e.g., FIG. 33C). Now turning to FIG. 33B, illustrating Cylinder locking mechanism 10″ having spur wheel 10′ (essentially a pinion) configured to engage rack 42 having gear ridges 420. It is noted, that so long as no key is inserted in key way 121 (see e.g., FIG. 33C), spur wheel 10′ rotates freely, and only upon insertion of a key, will spur wheel 10′ operably couple to cylinder lock 10″ such that rotating the key will operate locking fork 4 in a similar manner to motor 6. In other words, operating the key in keyway 121 will cause rack 41 to compress or expand biasing element 4100, allowing manipulation of locking fork 4 to open or close the lock. As illustrated in FIG. 33C, hasp body 1, further defines upper bore 1000, and lower bore 1000′ each defining a lateral slit 1001, 1001′ respectively, configured to accommodate lateral rod 70, 70′ of locking pin 7, 7′, respectively.

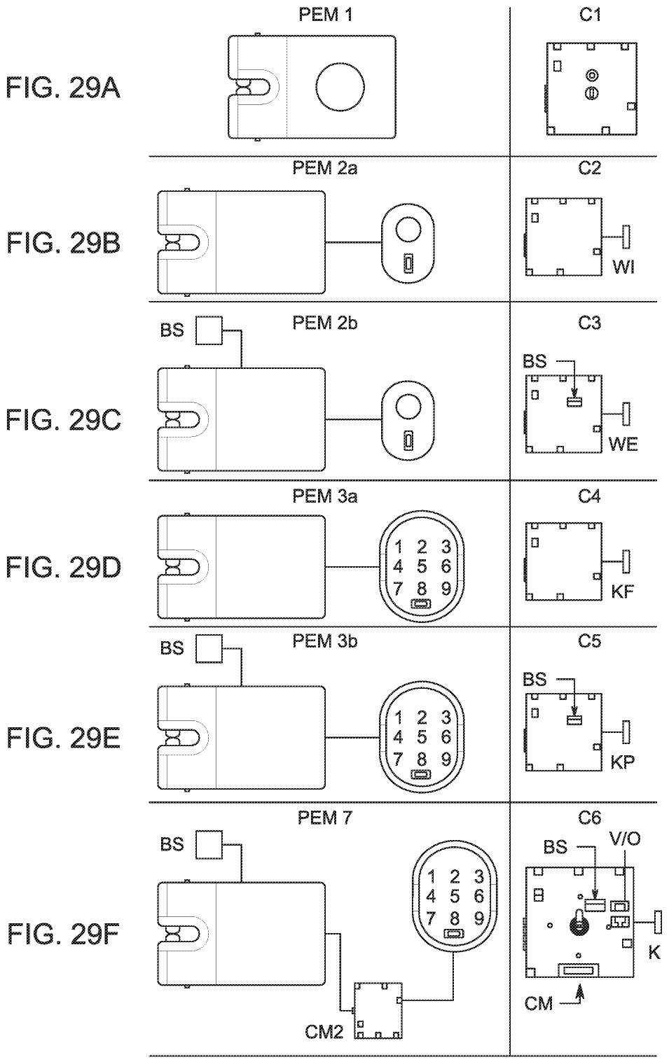

Locking device 10 described herein has been described in reference to exemplary implementations that are directly connected to a power supply where, for example, the power is supplied via (rechargeable or non-rechargeable) battery. Features of locking device 10 have been described primarily as they relate to the different power supply; however, all features of locking device 10 are interchangeable. For example, locking devices that are mounted on locker assemblies or locker doors, may be directly wired or powered via battery and either can include an initiation or wake-up switch to power locking device 10. In certain exemplary implementations where the locking device is mounted internal to the locker or internal to an object to be secured, the initiation or wake-up button would be mounted to allow access from outside the object (see e.g., FIG. 29A-29F).

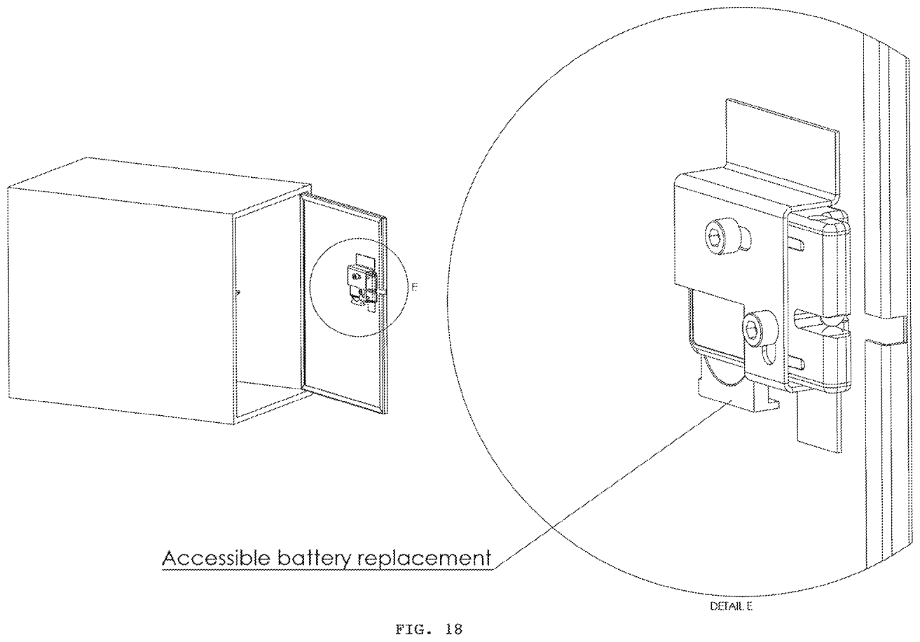

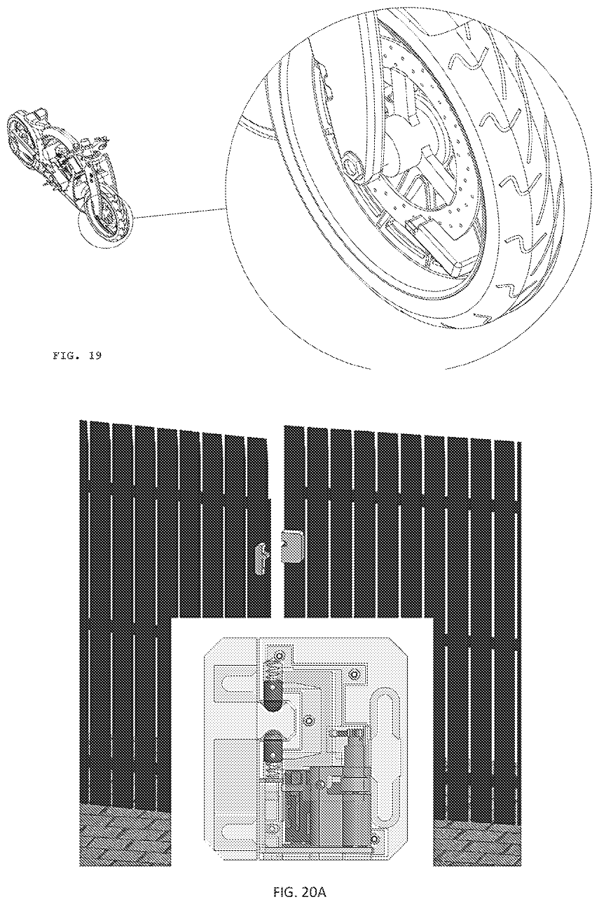

FIG. 18 illustrates in detail E, an enlarged partial view of locking device 10 of the exemplary implementation described and seen in relation to FIG. 17. In the enlarged view, a battery access opening can be seen. Slidable battery access cart is used in certain exemplary implementations to ensure correct insertion of the battery.

FIG. 19 illustrates one exemplary implementation of the invention where the locking device is used as an anti-theft device. In the exemplary implementation shown, locking device 10 is shown coupled to the disc brake of a motorcycle. As will be self-evident, locking device 10 as described herein may be used as an anti-theft device, alone or in combination with one or more attachment cables (not shown).

Locking device 10 as described includes a controller 155 capable of communicating with an electronic key to receive and carryout locking (and unlocking) instructions. As used herein “locking instructions” refers to any actions that may be undertaken by locking device 10 in response to one or more signals from the electronic key. As used herein “electronic key” refers to any device capable of providing locking instructions to locking device 10. The controller 155 as described can include any art recognized features useful in controlling locks, for example, the controller can include a clock, a calendar, and the like. The controller 155 is capable of storing and carrying out information and commands about locking device 10 operation. The controller has the capacity to receive and decrypt messages from the electronic key in Bluetooth®, near field communication methods or using other IOt protocols. The communications module of the controller is capable of communicating with HUBs, electronic keys, and other electromechanical locking devices on the same system, for example. The controller 155 includes controls to remove, update and allow users authorizations as appropriate.

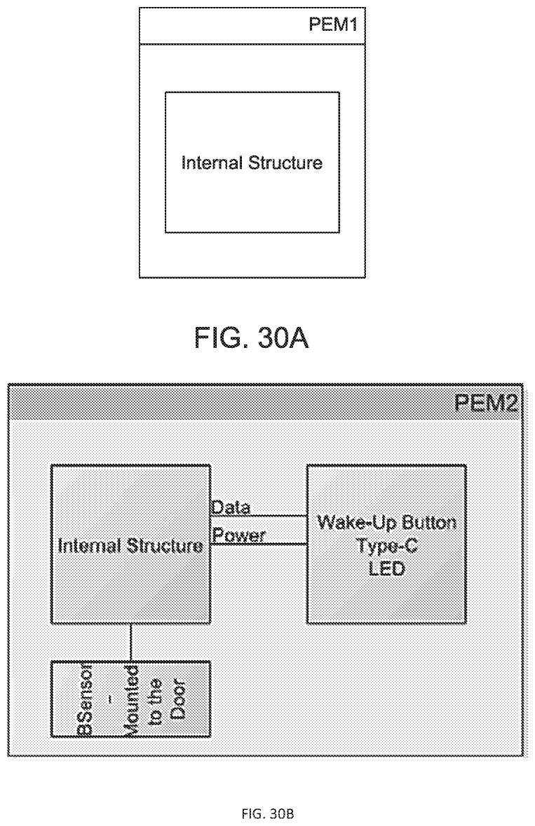

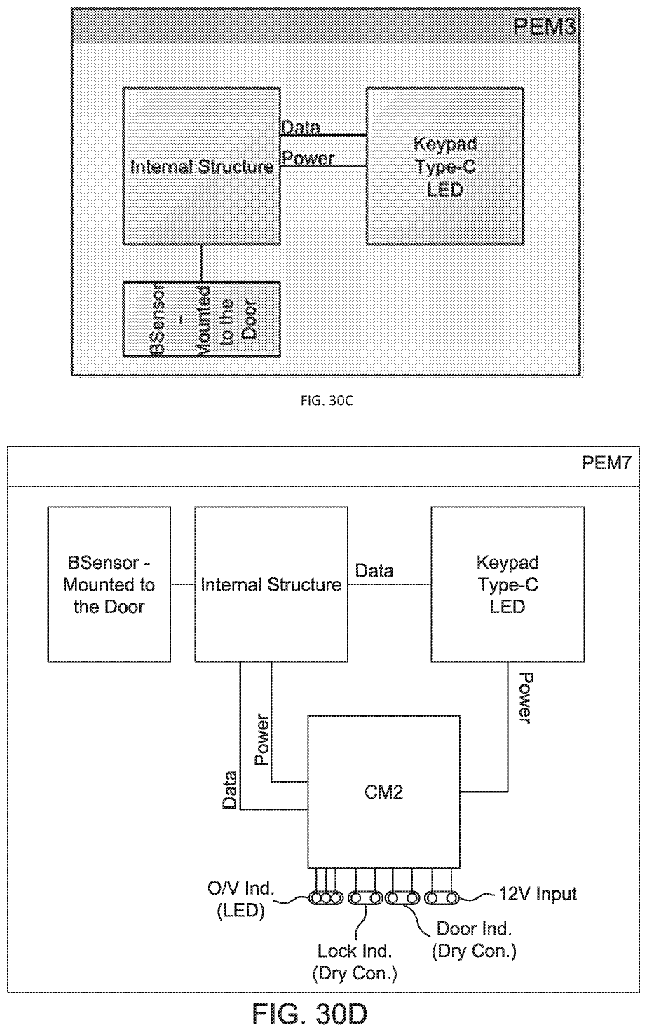

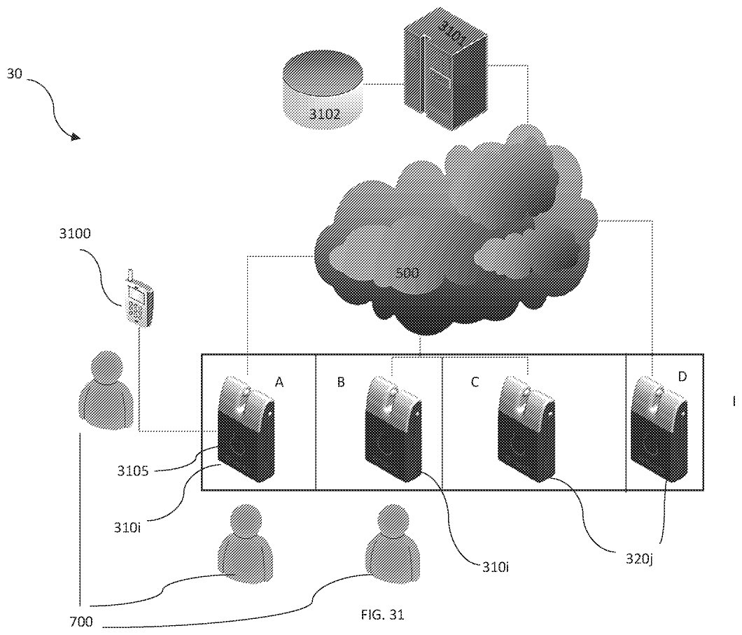

According to one exemplary implementation, rather than requiring a code to control access to the lock, the controller can be programmed to accept other art recognized forms of identification as appropriate including but not limited to fingerprints, electronic codes, pattern locks, and the like. For example, a control panel as illustrated in FIGS. 29A-29F. From a simple control panel as illustrated in FIG. 29A, and in corresponding schematic in FIGS. 30A.

The electronic key can take the form of a mobile computing device, a key fob, a remote control, or any other device operable to communicate with locking device 10. In some exemplary implementations, electronic keys may also take the form of unique biometric parameters such as fingerprints, retina pattern, voice recognition and the like. Smartphones, which are in near constant use for many people, are in an exemplary implementation, the electronic key most widely used. However, other mobile device that can be an electronic key include tablets, phablets, smart watches, personal Global Positioning System (GPS), fitness bands, or any other mobile computing devices. For exemplary implementations where locking device 10 and system as described are used in schools, dedicated control devices may be required if school policies forbid students to carry mobile computing devices during the school day. The dedicated control device can take the form of a remote control, key fob, a key card or other easily carried communication device.

For example, as illustrated in FIG. 31, electronic key 3100 is operable to receive access code from the lock management system 3101, or backend management server, in communication with user 700 database 3102 and communicate with locking device 310i. Electronic key 3100 may be in communication with a lock management system's backend management server 3101 using any art recognized method, for example, via the Internet 500, a private network, public network or other configuration that operates using any one or more known communication protocols such as, for example, transmission control protocol/Internet protocol (TCP/IP), Bluetooth®, Wi-Fi based on the Institute of Electrical and Electronics Engineers (IEEE) standard 802.11, Ultra-Wide Band (UWB), and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples. The electronic key will generally communicate with the locking device via Bluetooth® (BLE), near field communications (NFC), radio-frequency (RFID), ZIGBEE, WIFI and/or other IOT Protocols.

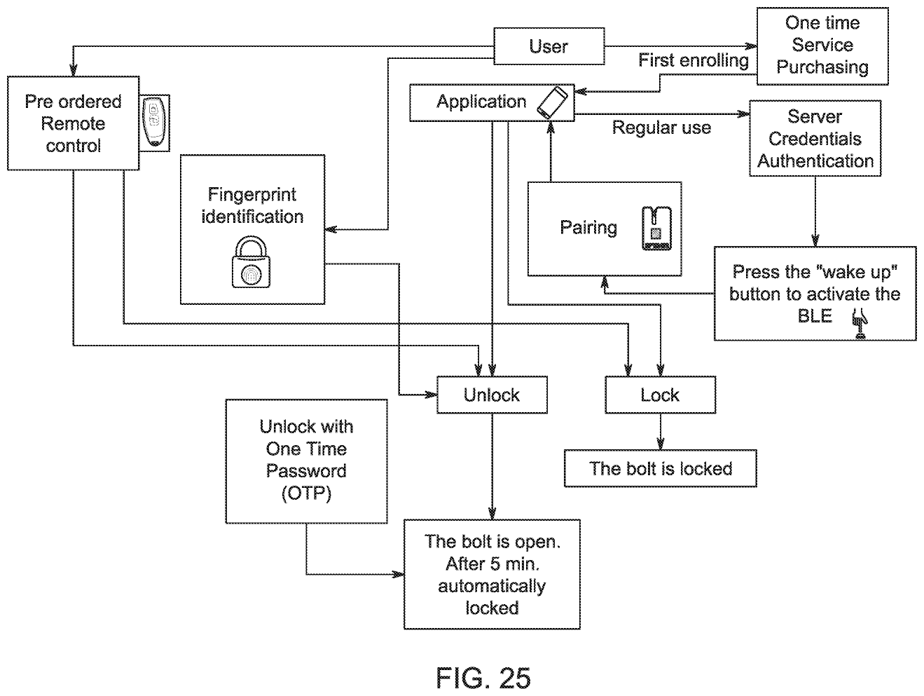

Locking device 310i as described herein may be managed via a lock management system 3101. Lock management system's backend management server 3101 includes the necessary hardware and software to engage users and accept payment for lock service packages. As described in detail below (see e.g., FIGS. 25-28), lock management system's backend management server 3101 enrolls lock users 700, provides them with initial access codes, provides them with on-going lock access via their electronic key, provides them with support services in the areas of lock maintenance and addresses access issues, by providing one-time access codes when their electronic key is unavailable.

Hardware components associated with the lock management system include processors, displays, sensors and input devices. The lock management system may also be carried out via mobile computing devices such as smartphones and tablet computers which contain these elements.

Software for use in the lock management system can include any computer-readable medium (also referred to as a processor-readable medium) including any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

Any now-existing or after-developed security protocols for user authentication including confirming user identity or electronic communication origination can be used with the lock management system as described herein. Appropriate security protocols can include, by way of example only, encrypted messaging. Any art recognized encryption protocols can be used including by way of example, 3DES, AES, RC5 and the like.

The lock management system will generally include a processor and a memory device for storing computer executable instructions, the processor being configured to execute the instructions to determine, via a processor of an electronic key, that a locking device is proximate the electronic key, determine, using user data that the electronic key is appropriate to access the locking device, send, responsive to determining that the access to the locking device by the electronic key is appropriate, a message providing an access code. The electronic key then being capable of transmitting the access code and/or locking instructions to locking device 10 via Bluetooth® (BLE), near field communications (NFC), radio-frequency (RFID), ZIGBEE, WIFI and/or other IOT Protocols.

In one exemplary implementation, the lock management system may communicate with locking device 10 via wired communication. For example, in the exemplary implementation shown in FIG. 15, the locking devices 10 are secured to the locker assemblies 173. In such an exemplary implementation, the locking devices 10 may be powered via battery or may be hard-wired to both power and communication systems. According to one exemplary implementation, the locking device may be connected to a 6 to 12 V DC power supply. In that instance, the controller 155 will have a communication interface that has been configured to facilitate wired communication between the lock management system and locking device 10. The user would still access locking device 10 via an electronic key and BLE, NFC or RFID communications.

Turning now to FIG. 25, in view of FIG. 31, where FIG. 25 is a flow chart illustrating an exemplary implementation of the lock management system. As seen in FIG. 25, in the first step a user 700 would interact, using e.g., wide area network (through cellular, wireless or local area network) with the lock management system's backend management server 3101 to solicit the use of a lock 310i and to set up how and for how long they would like to use the lock. On first interaction (e.g., through a dedicated web site) with lock management system's backend management server 3101, user 700 will identify:
a. provide a client ID (in other words, user name and password and other identifying parameters); AND
b. the location of the locker bank I (see e.g., FIG. 31), for example, a floor in a building, entrance location, etc. AND/OR
c. the specific locker within the locker bank (e.g., A, B, C, D); AND
d. the duration of the occupation of the specific locker.
   following payment using the same session, the lock management system's backend management server 3101 will issue user 700 an enrollment code (EC, could be e.g., an alphanumeric code, a numeric code, a letter code), which could be valid for a predetermined period, for example, between 10 minutes and 24 hours. User will then download an application to communication device 3100 equipped with Bluetooth (or NFC). The application being operable to communicate with the lock selected. In an example, communication device 3100 is equipped with Bluetooth communication module, and when user 700 reaches the proximity (distance where Bluetooth protocol is operable) of the selected lock, user 700, using wake-up button 3105, user 700 will power lock 310i, then using the downloaded application, user 700 will send the EC received to the lock management system's backend management server 3101, which, following authentication of the EC against the specific lock selected, and using a transceiver included with lock 310i, will pair communication device 3100 with the specific i^{th} lock 310i, according to the EC. Once communication device 3100 is successfully paired with the specific i^{th} lock 310i, there is no further need for wired or wireless communication between user 700 and lock management system's backend management server 3101, since internal clock included with each i^{th} lock 310i, will monitor the duration of operation, and once the EC defined period is reached, i^{th} lock 310i will terminate the operations. However, if wireless, cellular or other communication is possible, both i^{th} lock 310i, and communication device 3100 could be used to provide additional data, such as lock status and power source level. In those fixed within an enclosure (e.g., a locker), additional information transmitted to backend management server 3101, could be door status (open/closed).

Additionally, or alternatively, lock management system's backend management server 3101 can issue EC operable to provide access for a single opening of locker e.g. c, in locker bank I. For example, for a post-office packaging delivery, or any business wishing to have a client arrive at a specific location (with a locker bank) and collect an item in a secured manner. In that exemplary implementation, a third party reserves locker bank with lock management system's backend management server 3101. The third party will be able to operate all lockers and put an item within a given i^{th} lock 310i. Using the application in user 700 communication device, the third party can send client EC, incorporating the particular locker bank and the specific i^{th} lock 310i. Upon arrival of the client to the specific i^{th} lock 310i, and activating i^{th} lock 310i, using “wake-up” button 3105, user 700 will send the EC to lock management system's backend management server 3101, which will allow pairing of communication device 3100 with the specific i^{th} lock 310i, allowing for the specific i^{th} lock 310i to open. Upon detection of closing of the specific i^{th} lock 310i, or upon the passage of predetermined period (e.g., between 30 seconds and 5 minutes, communication device 3100 will automatically be decoupled from the specific i^{th} lock 310i.

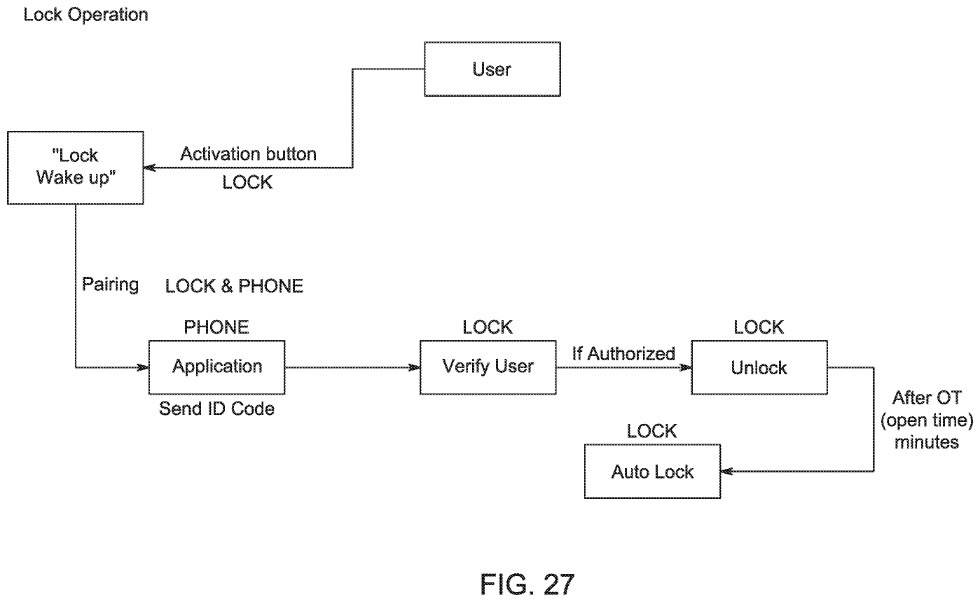

User 700 can also request an electronic key in the form of a key fob, or remote control or they can request a lock with biometric identification capability, such as a fingerprint reader. Once user 700 lock 310i and electronic key 3100 are enrolled, user 700 would, if available on the lock, activate wake-up button 3105 to power lock 310i. User 700 would then pair lock 310i with electronic key (interchangeable with communication device) 3100, be it an app on a mobile computing device or a key fob or remote. Electronic key 3100 would request credentials authentication lock management system's backend management server 3101 and if the user is authenticated (e.g., via database 3102, or through network authentication), would transmit a temporary code to electronic key 3100 allowing the key to send locking instructions to locking device 310i. As seen in FIG. 27, in an exemplary implementation, if a passcode is requested or used, the locking device could relock automatically after, for example, 5 minutes.

According to one exemplary implementation, processor 155, can include an automatic enrollment code generator. Accordingly and in an exemplary implementation, the enrollment code can include the user ID, the lock device ID, a period of use and an authorization code. When the enrollment code is transmitted to user 700, the associate App can be downloaded and his enrollment code introduced. User 700 can then bring the lock on-line, for example, by pressing wake-up button 3105, and then pair lock 310i with the app and send the enrollment code (via encrypted message) to locking device 310i. Once locking device 310i receives the enrollment code (EC), locking device 310i can allow user 700 access during the authorized period of use.

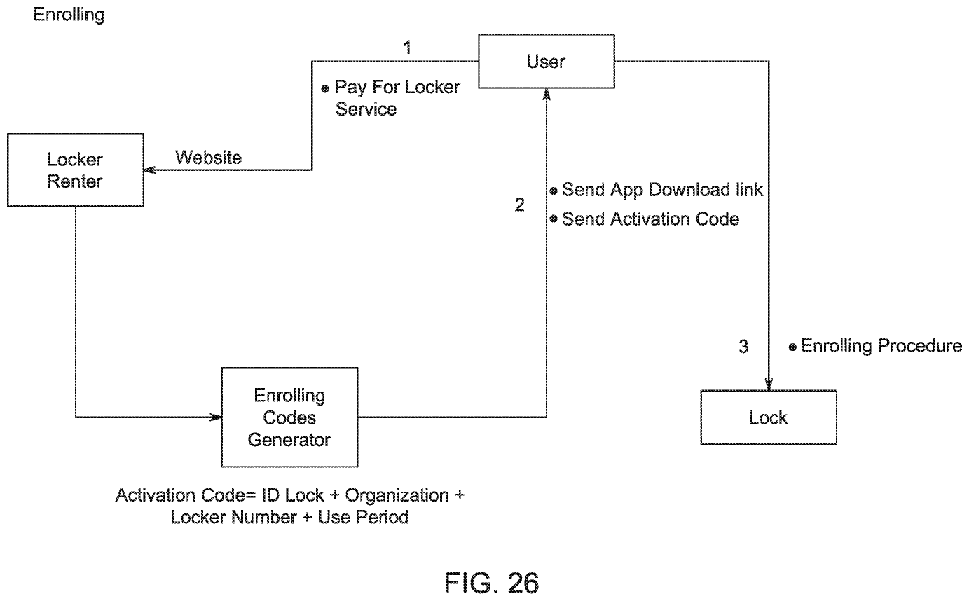

FIG. 26 is a flow chart illustrating an exemplary implementation associated with enrolling a lock via lock management system's backend management server 3101. As seen in FIG. 26, user 700 accesses lock 310i, e.g., available on a locker that they would like to use. User 700 can enroll via a website providing information on the lock and locker, the amount of time they would like to use the locking device, e.g., 1 day, 1 week, 1 year, and they can pay for the locking device and services. Once the user enrolls the desired lock, a lock activation code is generated and sent to the user along with a link to an app which can be used to control the locking device and the service contract. Once the user receives the activation code, he can activate the lock, via an activation button, and pair the lock with the app using the received activation codes.

FIG. 27 illustrates the locking operation for locking devices 310i as described. As discussed above, locking devices 310i (with those devices not in current use by lock management system's backend management server 3101 designated 320j) for use in the system are preferably maintained in a powerless configuration to conserve battery. Typically, user 700 would press an activation button to wake up locking device 310i and would pair electronic key 3100 to locking device 310i. Electronic key 3100 would generally be programmed and changed via an associated APP on a mobile computing device that would communicate with lock management system's backend management server 3101 and verify the user/electronic key and if authorized, would return a code to the APP that could then program another electronic key 3100 or could itself transmit the code to locking device 310i to unlock locking device 310i. Additionally, after locking device 310i had been open for a period of time, controller 155 can automatically relock the device, e.g., after 30 secs, 1 minute, 5 minutes. Alternatively locking device 310i could be configured to only lock back upon command from user 700.

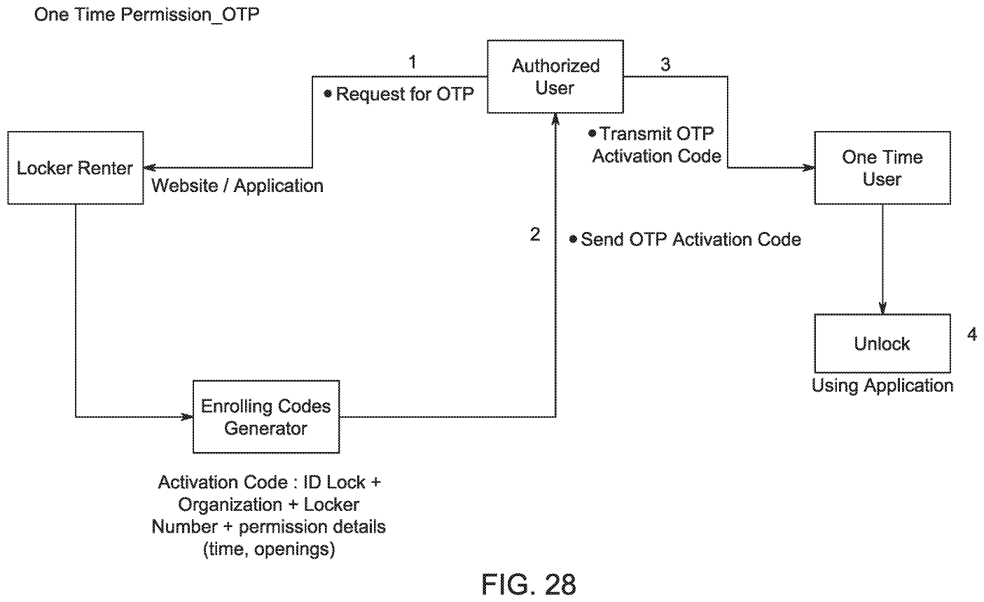

FIG. 28 illustrates a system for single permission requests for access to locking device 310i. In the event of an authorized long-term user 700, who, by way of example doesn't have key fob or smart phone, the request for single permission could be requested via phone or the internet using a computer or third-party mobile computing device. Upon authentication of the user, an activation code could be sent to the user. Alternatively, user 700 requesting a single time use or need to access a container or locker on an ad-hoc basis, a one-time permission code could be authorized and transmitted to the user. In this event, user 700 would use mobile computing device 3100 as an electronic key to transmit the unlock code to the locking device. In the event user 700 didn't have his own mobile computing device available, a one-time permission code could be authorized for another device by providing the lock management system with a phone number and personal ID number.

In one exemplary implementation, locking device 310i may further include a system for tracking the location of locking device 310i. The tracking system may be any art recognized location system. The tracking system may include a Global Positioning System (GPS) receiver configured or programmed to triangulate the position of the locking device. Since locking device 10 can be used to secure mobile items, for example, bicycles, motorcycles, scooters, packages, postal or currency bags, jewelry cases and the like, being able to track the lock using an associated mobile computing device provides an additional layer of security to the locking devices as described. Other location mechanisms could also be employed, for example through the use of RFIF locators, Bluetooth beacons and the like.

Turning now to FIG. 29A-29F, illustrating various configurations for securing enclosed structures, such as rooms, containers, lockers and the like. As illustrated in FIG. 29A, PEM1, (left) and its controller (right) will include the internal powertrain structure only (see e.g., FIG. 30A) a “wake-up” button, and optionally, a charging port (e.g., USB-c) coupled to a rechargeable battery. Furthermore, as shown in FIGS. 29B, and 30B; PEM 2a, can be further in communication with a biometric fingerprint reader coupled to the door to the enclosure, and the controller C2 will contain a status LED light, charging port and wake-up button 3105, with power and data communicated between locking device 310i powertrain and, and the biometric sensor. Likewise, as shown in FIG. 29C and FIG. 30C, PEM 2b can be further coupled to a magnetic proximity sensor disposed on the door, while controller C3, in addition to a status LED light, charging port and wake-up button 3105, will configure the LED light to display the status of the magnetic proximity sensor with power and data communicated between locking device 310i powertrain and, and the biometric sensor enabled. In addition, as shown in FIG. 29D, and 30C, PEM 3a, can be further in communication with a in numerical input key pad coupled to the door (e.g., to enter temporary code) to the enclosure, and the controller C4 will contain a status LED light, charging port and wake-up button 3105, with power and data communicated between locking device 310i powertrain and, and the keypad (KP). Likewise, as shown in FIG. 29E and FIG. 30C, PEM 3b can be further coupled to a magnetic proximity sensor (and or biosensor) disposed on the door, while controller C5, in addition to a status LED light, charging port and wake-up button 3105, will configure the LED light to display the status of the magnetic proximity sensor with power and data communicated between locking device 310i powertrain and, and the keypad enabled. Finally, in FIG. 29F and FIG. 30D, PEM 7, can be further in communication with a biosensor, a magnetic proximity sensor, and a keypad, and further have communication module CM2, coupled to the door to the enclosure, and the controller C6 will contain a plurality of status LED lights, charging port and wake-up button 3105, with power and data communicated between locking device 310i powertrain, and the coupled devices routed exclusively through CM2.

As will be readily understood by the skilled artisan, locking device 310i as described may be used to lock and secure any art recognized object. The locking system may be used by schools for securing locker systems, the system may be used by gym to secure their locker systems, the locking system may be used by shippers to secure pouches, luggage, and other valuables. The locking system may be used to restrain portable devices and equipment that can be accessed by a new user, for example, scooters, or construction sites. The locking system may be used.

According to another exemplary implementation, the smart locking device 10 as described can be used to secure other locking devices, for example, mechanical locks or key management systems. Locking device 10 can also be used as anti-vandal protection for locking cylinders.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one exemplary implementation,” “an exemplary implementation,” “an example exemplary implementation,” etc., indicate that the exemplary implementation described may include a particular feature, structure, or characteristic, but every exemplary implementation may not necessarily include the particular feature, structure, or characteristic. Moreover, such phrases are not necessarily referring to the same exemplary implementation. Further, when a feature, structure, or characteristic is described in connection with an exemplary implementation, one skilled in the art will recognize such feature, structure, or characteristic in connection with other exemplary implementations whether or not explicitly described.

It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

In the context of the disclosure, the term “operable” means the system and/or the device and/or the program, or a certain element or step is fully functional, sized, adapted and calibrated, comprises elements for, and meets applicable operability requirements to perform a recited function when activated, coupled, implemented, actuated, effected, realized, or when an executable program is executed by at least one processor associated with the system and/or the device. In relation to systems and circuits, the term “operable” means the system and/or the circuit is fully functional and calibrated, comprises logic for, having the hardware and firmware necessary, as well as the circuitry for, and meets applicable operability requirements to perform a recited function when executed by at least one processor.

Likewise, “operably coupled” refers to the joining of two members directly or indirectly to one another. Such joining may be stationary in nature or moveable in nature. Such joining may be achieved with the two members (or the two members and any additional intermediate) being integrally formed as a single unitary body with one another or with the two members or the two members and any additional members being attached to one another. Such joining may be permanent in nature or may be removable or releasable in nature.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various exemplary implementations and should in no way be construed to limit the claims.

Accordingly, it is to be understood that the above description is intended to be illustrative and not restrictive. Many exemplary implementations and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future exemplary implementations. In sum, it should be understood that the application is capable of modification and variation.

Unless specifically stated otherwise, as apparent from the foregoing discussions, it is appreciated that throughout the specification discussions utilizing terms such as “processing,” “loading,” “in communication,” “transferring”, “receiving”, “sending”, “detecting,” “calculating,” “determining”, “analyzing,” or the like, refer to the action and/or processes of a computer or computing system, or similar electronic computing device, that manipulate and/or transform data represented as physical, such as a transistor architecture into other data similarly represented as physical and structural layers.

As may also be used herein, the terms “module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions (in other words, firmware). The processor, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory, random access memory, transient memory, non-transient memory, static memory, dynamic memory, flash memory, cache memory, and/or any device that stores digital information.

The term “system” shall also be taken to include any collection of systems or sub-systems that individually or jointly execute a set, or multiple sets, of instructions to perform one or more functions. Also, the term “system” refers to a logical assembly arrangement of multiple devices, and is not restricted to an arrangement wherein all of the component devices are in the same housing, or physical location. Also, the term “server”, in the context of the disclosure, refers to a computer system, including processing hardware and process space(s), and an associated storage system and database application (e.g., OODBMS or RDBMS) as is well known in the art. It should also be understood that “server system” and “server” are often used interchangeably herein. Similarly, the database object described herein (3102) can be implemented as single databases, a distributed database, a collection of distributed databases, a database with redundant online or offline backups or other redundancies, etc., and might include a distributed database or storage network and associated processing intelligence such as, for example, machine learning algorithms

In an exemplary implementation non-transitory memory device, interchangeable with the terms “non-transitory storage medium” and/or “non-transitory computer-readable storage medium” refers to, any media that can contain, store, or maintain programs, information, and data. Non-transitory storage medium and non-transitory computer-readable storage medium may include any one of many physical media such as, for example, electronic, magnetic, optical, electromagnetic, or semiconductor media. More specific examples of suitable non-transitory storage medium and non-transitory computer-readable storage medium include, but are not limited to, a magnetic computer diskette such as floppy diskettes or hard drives, magnetic tape, a random access memory (RAM), a read-only memory (ROM), an erasable programmable read-only memory (EPROM), a flash drive, a compact disc (CD), or a digital video disk (DVD). The memory device may comprise other types of memory as well, or combinations thereof. In addition, the memory medium may be located in a first computer in which the programs are executed, and/or may be located in a second different computer which connects to the first computer over a network, such as the Internet. In the latter instance, the second computer may further provide program instructions to the first computer for execution. The term “memory device” can also include two or more memory devices which may reside in different locations, e.g., in different computers that are connected over a network.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain exemplary implementations could include, while other exemplary implementations may not include, certain features, elements, and/or steps. Thus, such conditional language is not generally intended to imply that features, elements, and/or steps are in any way required for one or more exemplary implementations.

Accordingly and in an exemplary implementation, provided herein is a low-profile locking device comprising: a lock housing having a channel for receiving an object to be secured; a lock housing cover; a locking structure contained between the lock housing and the lock housing cover that can be moved from a position inside the lock housing to a position spanning the channel when the locking device is locked, wherein (i) the locking structure is chosen from a locking bolt, a locking bar, ball bearings and a pivot pin, further comprising (ii) a gear motor and pinion for raising and lowering a rack for maintaining the locking structure in place, (iii) a controller for receiving a signal and engaging a motor gear in response to the signal to open or close the lock, (iv) a lock pin housing containing a biasing element actuated locking bolt as the locking structure and a locking pin for engaging the locking rack, wherein (v) the locking device is a mobile (in other words, portable) lock, wherein (vi) the controller is programmed to relock the locking device following at least one of: a specified period of inactivity, a specified period of activity, and a specified number of openings, the lock further comprising (vii) a “wake-up”button to reactivate the locking device from a powered-off mode, the button further operable to provide indication (e.g., using LED light) of the lock status (open, closed, pairing search, ready etc.), and wherein (viii) the locking device powers off following at least one of: a specified period of inactivity, a specified period of activity, and a specified number of openings, the locking device further comprising (ix) a redundant (unused) locking mechanism, wherein (x) the redundant locking mechanism is another electromechanical locking device, (xi) or a mechanical locking device, (xii) the mechanical locking device is a multi-point lock, (xii) further comprising a cam and associated key for moving the position of the rack and unlocking the locking device, wherein (xxii) the lock is a smart lock, wherein (xxiii) the controller is programmed to receive an encrypted authorization code that is make up of a lock ID, a lock position, a user ID and a use period, wherein (xxiv) the controller received locking signals from an electronic key chosen from a remote control via blue tooth, wherein (xxv) the locking structure is moved via mechanical motion associated with a key, further comprising (xxvi) a reactivation mechanism chosen from one or more of a motion sensor, a sound sensor or a touch sensor, wherein (xxvii) the lock housing cover comprises a channel that corresponds to the channel in the lock housing (xxviii) the locking structure remains in place across the channel after being opened by electronic key so that the lock also remains in place, wherein (xxix) the controller further comprises a clock and/or a calendar, the capacity to decipher Encrypted codes, the capacity to store information about operations and commands, the capacity to communicate by Bluetooth, near field communication methods or IoT (Internet of things) protocols, (xxx) the controller can communicate with HUBs, electronic keys chosen from phone, remote controller, special electronic key fob, (xxxi) the controller on one locking device is adapted to communicate with the controller on another locking device, and wherein the controller is programmed to allow or remove user authorizations according to the received commands.

In another exemplary implementation, provided herein is a locking system comprising: a low-profile locking device comprising a controller for receiving and executing locking instructions; a lock management system comprising a processor; and a memory for storing computer executable instructions, the processor configured to execute the instructions to: determine, via a processor of an electronic key, that a locking device is proximate electronic key (interchangeable with a communication device, or portable computing device, or a smart phone); determine, using user data, that electronic key is appropriate to access the locking device; send, responsive to determining that the access to the locking device by electronic key is appropriate, a signal providing an access code; wherein electronic key transmits the access code and locking instructions to the locking device via Bluetooth® (BLE), near field communications (NFC), radio-frequency (RFID), ZIGBEE, WIFI and/or other IOT Protocols, wherein (xiii) upon first interaction (e.g., through a dedicated web site) with lock management system's backend management server, the user will identify: provide a client ID (in other words, user name and password and other identifying parameters); the location of the locker bank I, for example, a floor in a building, entrance location, etc.; the specific locker within the locker bank (e.g., A, B, C, D); and the duration of the occupation of the specific locker, whereby following payment using the same session, the lock management system's backend management server issues the user an enrollment code (EC, could be e.g., an alphanumeric code, a numeric code, a letter code), operable to be valid for a predetermined period, wherein (xiv) the processor is configured to determine electronic key is proximate the locking device when electronic key request a change in the lock status of the locking device, (xi) generate one time permission codes, wherein (xv) the low-profile locking device comprises a lock housing having a channel for receiving an object to be secured; a lock housing cover having a channel that corresponds to the channel in the lock housing; a locking structure contained between the lock housing and the lock housing cover that can be moved from a position inside the lock housing to a position spanning the channel when the locking device is locked, and wherein the system further comprising (xvi) a series of locker assemblies, each locker assembly having a low-profile locking device coupled to the locker assembly.

In yet another exemplary implementation, provided herein is a non-transitory computer-readable storage medium comprising instructions that when executed by one or more processors cause the processors to perform acts comprising: determining, via a processor of an electronic key, that a locking device is proximate electronic key 3100; determining, using user data, that electronic key 3100 is appropriate to access the locking device; sending, responsive to determining that the access to the locking device by electronic key 3100 is appropriate, a message providing an access code; wherein electronic key 3100 transmits the access code and locking instructions to the locking device via Bluetooth® (BLE), near field communications (NFC), radio-frequency (RFID), ZIGBEE, WIFI and/or other IOT Protocols.

In an exemplary implementation, provided herein is a locker system comprising: a locker to be secured; and a low-profile locking device comprising a lock housing having a channel for receiving an object to be secured; a lock housing cover having a channel that corresponds to the channel in the lock housing; a locking structure contained between the lock housing and the lock housing cover that can be moved from a position inside the lock housing to a position spanning the channel when the locking device is locked, as well as (xvii) a lock management system comprising a processor; and a memory for storing computer executable instructions, the processor configured to execute the instructions to: determine, via a processor of an electronic key, that a locking device is proximate electronic key; determine, using user data, that electronic key is appropriate to access the locking device; send, responsive to determining that the access to the locking device by electronic key is appropriate, a signal providing an access code; wherein electronic key transmits the access code and locking instructions to the locking device via Bluetooth® (BLE), near field communications (NFC), radio-frequency (RFID), ZIGBEE, WIFI and/or other IOT Protocols, wherein (xviii) the processor is configured to determine electronic key is proximate the locking device when electronic key request a change in the lock status of the locking device, and/or (xix) generate one time permission codes, wherein (xx) low-profile locking device comprises a battery, (xxi) is wired into a power system,

What is claimed:

1. A low-profile locking device comprising:
a lock housing having a channel for receiving an object to be secured;
a lock housing cover;
a locking structure contained between the lock housing and the lock housing cover that can be moved from a position inside the lock housing to a position spanning the channel when the locking device is locked.

2. The locking device according to claim 1, wherein the locking structure is chosen from a locking bolt, a locking bar, ball bearings and a pivot pin.

3. The device according to claim 1, further comprising:
a gear motor and pinion for raising and lowering a rack for maintaining the locking structure in place.

4. The locking device according to claim 3, further comprising:
a controller for receiving a signal and engaging a motor gear in response to the signal to open or close the lock.

5. The locking device according to claim 3 further comprising:
a lock pin housing containing a biasing element actuated locking bolt as the locking structure and a locking pin for engaging the locking rack.

6. The locking device according to claim 5 wherein the locking device is a portable lock.

7. The locking device according to claim 4 wherein the controller is programmed to relock the locking device after at least one of: a specified period of inactivity, a specified period of activity, a number of openings, and loss of communication signal.

8. The locking device of claim 1, further comprising a button to reactivate the locking device from a powered-off mode.

9. The locking device of claim 8, wherein the locking device powers off following at least one of: a specified period of inactivity, a specified period of activity, a specified number of openings, and loss of communication signal.

10. A locking system comprising:
a low-profile locking device comprising a controller for receiving and executing locking instructions;
a lock management system comprising a processor; and
a memory for storing computer executable instructions, the processor configured to execute the instructions to:
determine, via a processor of an electronic key, that a locking device is proximate electronic key;
determine, using user data, that electronic key is appropriate to access the locking device;
send, responsive to determining that the access to the locking device by electronic key is appropriate, a signal providing an access code;
wherein electronic key transmits the access code and locking instructions to the locking device via Bluetooth® (BLE), near field communications (NFC), radio-frequency (RFID), ZIGBEE, WIFI and/or other IOT Protocols.

11. The system of claim 10, wherein the processor is configured to determine electronic key is proximate the locking device when electronic key request a change in the lock status of the locking device.

12. The system of claim 10, wherein the processor is configured to generate one time permission codes.

13. The system of claim 10, wherein the low-profile locking device comprises a lock housing having a channel for receiving an object to be secured;
a lock housing cover having a channel that corresponds to the channel in the lock housing;
a locking structure contained between the lock housing and the lock housing cover that can be moved from a position inside the lock housing to a position spanning the channel when the locking device is locked.

14. The system of 10, further comprising a series of locker assemblies, each locker assembly having a low-profile locking device coupled to the locker assembly.

15. A non-transitory computer-readable storage medium comprising instructions that when executed by one or more processors cause the processors to perform the steps comprising:
determining, via a processor of an electronic key, that a locking device is proximate electronic key;
determining, using user data,
that electronic key is appropriate to access the locking device;
sending, responsive to determining that the access to the locking device by electronic key is appropriate, a message providing an access code;
wherein electronic key 3100 transmits the access code and locking instructions to the locking device via Bluetooth® (BLE), near field communications (NFC), radio-frequency (RFID), ZIGBEE, WIFI and/or other IOT Protocols.

16. The locking device of 1, further comprising a redundant locking mechanism.

17. The locking device of claim 16, wherein the redundant locking mechanism is another electromechanical locking device.

18. The locking device of claim 16, wherein the redundant locking mechanism is a mechanical locking device.

19. The locking device of claim 18, wherein the mechanical locking device is a multi-point lock.

20. The locking device of claim 3, further comprising a cam and associated key for moving the position of the rack and unlocking the locking device.

21. A locker system comprising:
a locker to be secured; and
a low-profile locking device comprising
a lock housing having a channel for receiving an object to be secured;
a lock housing cover having a channel that corresponds to the channel in the lock housing;
a locking structure contained between the lock housing and the lock housing cover that can be moved from a position inside the lock housing to a position spanning the channel when the locking device is locked.

21. The locker system of claim 20, further comprising a lock management system comprising
a processor; and
a memory for storing computer executable instructions, the processor configured to execute the instructions to:
determine, via a processor of an electronic key, that a locking device is proximate electronic key;
determine, using user data, that electronic key is appropriate to access the locking device;
send, responsive to determining that the access to the locking device by electronic key is appropriate, a signal providing an access code; wherein electronic key transmits the access code and locking instructions to the locking device via Bluetooth® (BLE), near field communications (NFC), radio-frequency (RFID), ZIGBEE, WIFI and/or other IOT Protocols.

22. The locker system of claim 21, wherein the processor is configured to determine electronic key is proximate the locking device when electronic key request a change in the lock status of the locking device.

23. The locker system of claim 21, wherein the processor is configured to generate one time permission codes.

24. The locker system of claim 20, wherein the low-profile locking device comprises a battery.

25. The locker system of claim 20, wherein the low-profile locking device is wired into a power system.

26. The locking device of claim 4, wherein the controller is programmed to receive an encrypted authorization code that is make up of a lock ID, a lock position, a user ID and a use period.

27. The locking device of claim 4, wherein the controller received locking signals from an electronic key chosen from a remote control via blue tooth.

28. The locking device of claim 1, wherein the locking structure is moved via mechanical motion associated with a key.

29. The locking device of claim 1, further comprising a reactivation mechanism chosen from one or more of: a motion sensor, a sound sensor, a biometric sensor, or a touch sensor.

30. The locking device of claim 1, wherein the lock housing cover comprises a channel that corresponds to the channel in the lock housing.

31. The locking device of claim 1, wherein the locking structure remains in place across the channel after being opened by electronic key so that the lock also remains in place.

32. The locking system of claim 10, wherein the controller further comprises a clock and/or a calendar, the capacity to decipher Encrypted codes, the capacity to store information about operations and commands, the capacity to communicate by Bluetooth, near field communication (NFC) methods or internet of things (IoT) protocols.

33. The locking system of claim 10, wherein the controller can communicate with hubs, electronic keys chosen from phone, remote controller, electronic key fob.

34. The locking system of claim 10, wherein the controller on one locking device is operable to communicate with the controller on another locking device.

35. A system for managing access to at least one enclosure; the system comprising:
a. the at least one enclosure, configured to be enclosed using a networked lock;
b. a plurality of the networked locks, each lock specifically associated with a corresponding enclosure, wherein each network lock comprises:
i. a transceiver;
ii. a Bluetooth module;
iii. an electromagnetic motor;
iv. a locking mechanism coupled to the electromagnetic motor, operable to bias at least one ball bearing in a pair of ball toward an opposing ball bearing; and
v. a processor, in communication with the transceiver, the Bluetooth module, and the electromagnetic motor, the processor being in further communication with a non-transitory memory device storing thereon a set of executable instructions, configured, when executed, to cause the processor to receive a pairing command from a backend management server; and using the Bluetooth pair the lock to a user's portable computing device.
c. the backend management server, in communication with each transceiver of the networked locks, the backend management server, further comprises a central processor in communication with a non-transitory memory device storing thereon a set of executable instructions, configured when executed to:
i. receive an inquiry from the user;
ii. obtain from the user a user identification; an enclosure location, an enclosure type; and duration of occupation of the enclosure;
iii. Upon payment by the user, issue to the user an enrollment code, the enrollment code specifically associated with the networked lock associated with the enclosure type in the location specified by the user;
iv. receive from the user the enrollment code;
v. issue the pairing the networked lock associated with the enclosure type in the location specified by the user to pair.

36. The system of claim 10, wherein the locking device is a hasp lock comprising:
a. a hasp body comprising:
i. a housing, defining a groove operable to accommodate a protrusion defined in a hasp strike, the housing further defining an upper bore and a lower bore above and below the groove:
ii. a locking fork;
iii. a motor operably coupled to the locking fork;
iv. a cylinder lock operably coupled to the locking fork;
v. an upper locking pin, sized and configured to be accommodated within the upper bore, the upper locking pin is comprised of a pin head, and a lateral rod;
vi. a lower locking pin, sized and configured to be accommodated within the lower bore, the lower locking pin is comprised of a pin head, and a lateral rod;
vii. a central processing module (CPM), in communication with the motor, the CPM further comprising at least one processor in communication with a non-transitory memory device storing thereon a set of executable instructions, configured when executed to cause the at least one processor to activate the motor thereby operating the locking fork to transition the lock from a locked position to an unlocked position
b. a hasp strike comprising a hasp strike body defining a protrusion sized and configured to be accommodated within the groove, the protrusion having an apical surface and a basal surface, each apical and basal surface defining a depression sized and configured to engage a portion of the upper locking pin's pin-head, and the lower locking pin's pin-head.
